(19) United States
(12) Patent Application Publication
(10) Pub. No.: US 2003/0170028 A1
(43) Pub. Date: Sep. 11, 2003

(54) Optical transmitter, optical repeater, optical receiver and optical transmission method

(75) Inventors: Shota Mori, Kawasaki (JP); Futoshi Izumi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/410,436

(22) Filed: Apr. 10, 2003

Related U.S. Application Data
(63) Continuation of application No. PCT/JP00/07280, filed on Oct. 19, 2000.

(51) Int. Cl. H04J 14/02; H04B 10/00

(52) U.S. Cl. 398/79; 398/97; 398/202; 398/182

(57) ABSTRACT

An optical transmitter is provided with: an optical signal generator for generating a main signal to be transmitted and its inversion signal as optical signals of different wavelengths; and a wavelength division multiplexer for wavelength division multiplexing the optical signals of different wavelengths generated by the optical signal generator and transmitting the multiplexed optical signal. By transmitting the main signal to be transmitted and its inversion signal as the wavelength division multiplexed optical signal (containing optical signals of different wavelengths corresponding to the main signal and the inversion signal), “inter-channel crosstalk” which occurs during multi-wavelength batch amplification by an optical amplifier (Raman amplifier, semiconductor optical amplifier, etc.) can be suppressed effectively, independently of the performance/characteristics of optical devices.

### TECHNICAL FIELD

The present invention relates to an optical transmitter, an optical repeater, an optical receiver and an optical transmission method, and in particular, to those suitably employed for a WDM (Wavelength Division Multiplex) optical transmission system in which transmission loss of an optical signal (WDM optical signal) occurring in an optical fiber transmission line is compensated for in a lump using an optical amplifier.

### BACKGROUND OF THE INVENTION

In recent years, WDM (Wavelength Division Multiplex) optical transmission technologies employing rare-earth doped optical fiber amplifiers such as EDFAs (Erbium Doped Fiber Amplifiers) are being introduced and brought into practical use in order to meet the demand for information communication which is rapidly increasing with the prevalence of the Internet. However, in order to support future communications networks which will mainly be used for data traffic, information communication systems having far broader bandwidths than ever have to be provided at low cost.

It is therefore becoming necessary to reduce costs of the whole system by increasing the wavelength multiplicity (by raising the wavelength division multiplexing density and expanding the amplification bandwidth of the fiber optical amplifier) and extending the signal repeating intervals. Meanwhile, expectations are growing for the realization of a photonic network, in which switching and routing are conducted in the optical range.

In order to meet the above requirements, cost reduction, miniaturization, and reduction of power consumption are required of the optical amplifier. At present, apart from the rare-earth doped optical fiber amplifiers such as EDFAs, there exist various types of optical amplifiers such as Raman amplifiers and semiconductor optical amplifiers. The realization of an optical amplifier capable of complementing the rare-earth doped optical fiber amplifier and meeting the above requests by making full use of diverse features of various optical amplifiers is now being hoped for.

For example, the Raman amplifier is attracting attention as a method for widening the amplification (gain) band of the optical amplifier. In a rare-earth doped optical fiber amplifier such as EDFA, the optical signal is amplified using the state transition between energy levels of a rare-earth element which has been added to the optical fiber, therefore, the band (wavelength range) in which the optical amplification is possible varies depending on what the added element is. In the case of EDFA for example, the gain band is limited to approximately 1530-1600 nm.

On the other hand, the Raman amplifier, which amplifies the optical signal employing the “stimulated Raman scattering” occurring in the optical fiber, has different amplification characteristics exhibiting a gain peak at a wavelength slightly (approximately 100 nm) longer than the pumping wavelength. In other words, the optical amplification using the Raman amplifier can be carried out at any wavelength band by properly selecting the wavelength of the pump light. Therefore, it is possible to realize a broader gain band by connecting a Raman amplifier and a rare-earth doped optical fiber amplifier (EDFA etc.) in series.

Incidentally, the aforementioned “stimulated Raman scattering” is a type of the so-called “Raman scattering”, in which when high power light is inputted to an optical fiber, part of the input light power is consumed by lattice vibration in the optical fiber and thereby part of the input light is transformed into light (called “Stokes light” or “spontaneous Raman scattering light” ) having a wavelength longer than that of the input light. The stimulated Raman scattering employs the fact that such wavelength transformation is enhanced by the existence of light having the wavelength of the Stokes light.

In the Raman amplification, multiplied gain (superposition of gain) can be obtained by use of various pump lights of different wavelengths, therefore, some methods for broadening the gain band employing such phenomenon have been proposed (e.g. Japanese Patent Application Laid-Open No. HEI10-73852). Further, since the optical fiber transmission line itself is used as the amplification medium in the Raman amplification, the optical signal amplification in the Raman amplifier takes place in a “distributed constant”-like manner. Therefore, the Raman amplification is capable of conducting amplification with lower noise, compared to a rare-earth doped optical fiber amplifier having equivalent gain (in which amplification occurs in a “lumped constant”-like manner) (reference: “Nonlinear Fiber Optics” published by Academic Press).

Therefore, the transmission distance of the optical signal can be extended by combining a Raman amplifier with the rare-earth doped optical fiber amplifier such as EDFA, as described in Japanese Patent Application Laid-Open No. HEI10-22931, for example. FIG. 21 shows an example employing such a combination, in which a WDM optical transmission system is equipped with an optical repeater 100 that includes: a rare-earth doped optical fiber amplifier 110 (including a rare-earth doped optical fiber 111, a pump light source 112 for the rare-earth doped optical fiber 111, and an optical coupler 113); a pump light source 121 for Raman amplification; and an optical coupler 122 for inputting the optical output of the pump light source 121 to an optical fiber transmission line 101. The reference numeral “102” in FIG. 21 denotes another optical fiber transmission line which transmits the amplified optical output of the rare-earth doped optical fiber amplifier 110.

The pump light source 121 generates pump light having: a particular wavelength suitable for causing the Raman amplification (stimulated Raman scattering) in the optical fiber transmission line 101 at the wavelength of the optical signal; and a particular optical output level capable of realizing a necessary gain. The pump light outputted by the pump light source 121 is transmitted to the optical fiber transmission line 101 (in a direction opposite to that of the optical signal) via the optical coupler 122.

The pump light from the pump light source 121 causes the stimulated Raman scattering in the optical fiber transmission line 101, thereby the optical signal (hereafter, also referred to as “signal light” ) propagating through the optical fiber transmission line 101 is amplified (Raman amplification) and thereby the optical signal to be inputted to the optical repeater 100 is amplified to a preset level. Therefore, in the optical repeater 100 for obtaining a predetermined optical output level, the rare-earth doped optical fiber amplifier 110 is required less gain (repeating gain) compared to the case where no Raman amplification is employed. As a result, a certain margin is given to the gain of the rare-earth doped optical fiber amplifier 110, and the optical signal transmission length (within which negative effect of amplification noise from the rare-earth doped optical fiber amplifier 110 is permissible) can be extended.

When a WDM optical transmission system is built up employing aplurality of optical repeaters 100 as shown in FIG. 22 for example, the level of an optical signal, which is transmitted from an optical transmitter 130 to an optical receiver 140 being repeated by each optical repeater 100, decreases each time it passes through an optical fiber transmission line 101 (102). However, the optical signal is amplified each time by means of the Raman amplification as shown with the solid line 200 in FIG. 22, by which the optical input level of each optical repeater 100 becomes higher compared to the case without Raman amplification (dotted line 300), and the repeating gain required of the rare-earth doped optical fiber amplifier 110 is reduced. In this case, the spontaneous emission noise is also reduced as shown with the solid line 400 in FIG. 22 compared to the case without Raman amplification (dotted line 500).

Consequently, in comparison with the case without Raman amplification, the repeating distance between the optical repeaters 100 can be extended and the number of optical repeaters necessary for building up a WDM optical transmission system for a predetermined transmission distance can be decreased, thereby enabling the system to be built up at a lower cost.

Incidentally, as an optical amplifier suitable for implementing the photonic network, expectations are growing for the aforementioned semiconductor optical amplifier is expected to have a smaller size and lower power consumption compared to fiber optical amplifiers such as the rare-earth doped optical fiber amplifiers. Having high-speed switching characteristics different from the fiber optical amplifiers such as EDFA, the semiconductor optical amplifiers are being expected to be especially applicable to optical gate elements of optical cross-connect (reference: S. Araki et al. “A 2.56 Tb/s Throughput Packet/Cell-based Optical Switch-Fabric Demonstrator”, Technical Digest of ECOC'98, vol.3, page 127).

Further, the semiconductor optical amplifiers, being semiconductor-based devices, can also be implemented as a multi-channel array module, by means of hybrid integration with a silica-based planar optical circuit.

As above, the Raman amplifier and the semiconductor optical amplifier are leading candidates for next-generation optical amplifiers. However, due to their far higher speed of response compared to the fiber optical amplifiers (EDFA etc. ), a new problem that was not found in fiber optical amplifiers: inter-wavelength (inter-channel) crosstalk, is arising.

For example, in the case of EDFA (having a response speed in the order of msecs (milliseconds) due to the relatively long relaxation time of erbium atoms), even if a modulated optical signal in the order of Gbps (gigabits per second) is inputted, the waveform of the optical signal is not distorted since an EDFA having a slow response speed is only capable of detecting average optical power. On the other hand, the stimulated Raman scattering effect in the optical fiber (as the basis of the Raman amplification) is known to have an extremely high response speed in the order of ps (picoseconds) since the stimulated Raman scattering is a non-linear interaction among various signal lights of all wavelengths propagating through the optical fiber.

Therefore, in a “gain saturation state” with a high optical input level (see FIGS. 23(A) and 23(B)), the pump light P (wavelength: λ0) amplifying the intensity-modulated signal light Q (wavelength: λ1) is deprived of its energy and thereby the intensity of the pump light P is modulated according to the modulation pattern of the intensity-modulated signal light Q (also expressed as “Fluctuation occurs in the pump light P.”). When multiple wavelengths are amplified in a lump (that is, when multi-wavelength batch amplification is carried out), the fluctuation of the pump light P is converted to fluctuation of the amplification factor of another signal light, thereby causing the inter-wavelength (inter-channel) crosstalk.

For example, when a first signal light Q having a wavelength λ1 (bit pattern=101) and a second signal light Q′ having a wavelength λ2 (bit pattern=111) are amplified in a lump (batch amplification) by pump light P (wavelength: λ0) as schematically shown in FIGS. 24(A) and 24(B), the fluctuation occurs in the pump light P as shown in FIG. 24(C) since the intensity of the pump light P simultaneously amplifying the same bit values (1, 1) (see “201” in FIG. 24(C)) differs from the intensity of the pump light P simultaneously amplifying different bit values (1, 0) (see “202” in FIG. 24(C)).

In this case, the intensity of the pump light P simultaneously amplifying different bit values (1,0) (see “202”) is converted to the amplification factor for the bit value “1” of the signal light Q′, by which the waveform of the signal light Q′ is distorted from the original shape as shown with a reference numeral “203” in FIG. 24(C). This is the “inter-channel crosstalk”.

There are three types of configurations of the Raman amplifier as shown in FIGS. 25 (A) through 25(C). In the example of FIG. 25 (A), a Raman pump light source 121 and an optical coupler 122 are placed in front of an optical fiber transmission line 103 and the pump light is inputted to the optical fiber transmission line 103 in the same direction as the optical signal propagation direction (forward-pumping). On the other hand, in the example of FIG. 25 (B), a Raman pump light source 121 and an optical coupler 122 are placed after an optical fiber transmission line 103 and the pump light is inputted to the optical fiber transmission line 103 in the opposite direction to the optical signal propagation direction (backward pumping). The Raman amplifier in FIG. 21 (employing the optical fiber transmission line 101) is this type. As shown in FIG. 25(C), the forward-pumping and the backward-pumping are combined together (bidirectional-pumping).

Among the above three types, the forward-pumping, in which the signal light intensity at the pump light input point (coupling point) is high and the pump light and the signal light propagate in the same direction, is known to involve strong “inter-channel crosstalk” [reference: OPTRONICS (1999) No. 8 (Noboru Edagawa), “Bandwidth of Cross Talk in Raman Amplifiers”, OFC'94 Technical Digest (Fabrizio Forghieri et al.), etc.]. Therefore, when the forward-pumping is employed, waveform degradation caused by the “inter-channel crosstalk” becomes a factor that limits the transmission distance.

On the other hand, in the backward pumping in which the pump light and the signal light propagate in opposite directions, the negative effect of the “inter-channel crosstalk” (hereafter, also simply referred to as “crosstalk”) is small; however, due to high intensity of the pump light and low intensity of the signal light at the coupling point, spontaneous Raman scattering light is easily generated, causing inferior noise characteristics as a demerit of the backward pumping. Therefore, in order to extend the intervals between optical repeaters using the Raman amplifiers, it is effective to suppress the effect of “crosstalk” in some way and optimize the bidirectional-pumping making full use of the merits of the forward-pumping and the backward pumping.

Incidentally, the effect of “crosstalk” becomes negligible when the pump light intensity is high enough relative to the signal light intensity, and thus it is possible to avoid the crosstalk effect by increasing the pump light intensity. However, the pump light intensity varies depending on the performance of the optical device (semiconductor laser etc.). At present, the intensity of pump light outputted by an optical device is limited to some hundreds of milliwatts (mW), and thus supplying enough optical power becomes difficult as the number of wavelengths increases. Therefore, it is essential to suppress the “crosstalk” in some way.

Meanwhile, it is known that such “crosstalk” also occurs in the semiconductor optical amplifiers in a similar manner. Specifically, since the semiconductor optical amplifier is a device which amplifies the incident light by means of stimulated emission employing the population inversion which is caused by carrier injection to a semiconductor active layer, carrier density in the active layer changes depending on the intensity of the incident light.

Therefore, the relaxation time of carriers comes into question similarly to the case of the Raman amplifier. As the carrier relaxation time in the semiconductor optical amplifier is in the sub-nanosecond order [reference: Mukai et al. “1.5 μm band InGaAsP/InP Resonance Laser Amplifier”, The Transactions of the Institute of Electronics, Information and Communication Engineers, Vol.J69-C, No. 4, pp.421-431 (1986)], the semiconductor optical amplifier will have a response speed like that of the Raman amplifier when amplifying input signal light having a modulation frequency in the order of Gbps.

Due to the fast response speed, the carrier density variation in the semiconductor optical amplifier exhibits a tendency to follow the change of the input signal light intensity as schematically shown in FIGS. 26(A) through 26(C), thereby waveform distortion according to the input signal light pattern (called “pattern effect”) occurs to the output light in the gain saturation state. As a result, the “inter-channel crosstalk” also occurs when the multi-wavelength batch amplification is carried out by the semiconductor optical amplifier. FIGS. 27(A) through 27(E) illustrate the occurrence of the inter-channel crosstalk during the multi-wavelength batch amplification.

Referring to the figures, when modulated input light “1” (FIG. 27(A)) and DC (direct current) input light “2” (FIG. 27(B)) are inputted to the semiconductor optical amplifier, the carrier density varies according to the variation of total light power in the active area (active layer) (FIG. 27(C)), by which the amplification factor of every channel is modulated. Consequently, waveform distortion occurs to the modulated output light “1” as shown in FIG. 27(D), and crosstalk dependent on the output light “1” occurs to the output light “2” as shown in FIG. 27(E).

Incidentally, the above phenomenon, occurring in the gain saturation state, can be avoided by increasing the saturation power of the semiconductor optical amplifier; however, there are certain limits in device characteristics similar to the case of the Raman amplifier. Therefore, also in the semiconductor optical amplifier, the crosstalk has to be suppressed in some way.

The present invention has been made in consideration of the above problems. It is therefore the primary object of the present invention to effectively suppress the inter-channel crosstalk that occurs during multi-wavelength batch amplification carried out by an optical amplifier such as the Raman amplifier and the semiconductor optical amplifier, with a method that works independently of the performance/characteristics of optical devices.

### DISCLOSURE OF THE INVENTION

In order to achieve the above object, an optical transmitter in accordance with the present invention comprises: optical signal generating means for generating a main signal to be transmitted and its inversion signal as optical signals of different wavelengths; and wavelength division multiplexing means for wavelength division multiplexing the optical signals of different wavelengths generated by the optical signal generating means and transmitting the multiplexed optical signal.

The main signal to be transmitted and its inversion signal are transmitted by the above optical transmitter as a wavelength division multiplexed optical signal containing optical signals of different wavelengths corresponding to the main signal and the inversion signal, thereby the total optical power of the main signal and the inversion signal can be maintained constant. Therefore, even if the main signal and the inversion signal are amplified by pump light in a lump, the aforementioned fluctuation occurring to the pump light (in which the intensity of pump light is modulated according to the waveform of the main signal) can be suppressed independently of the characteristics of optical devices and thereby crosstalk between the main signals can be eliminated securely.

It is preferable that the main signal and the inversion signal be outputted in a synchronized state, by which the two signals are wavelength division multiplexed and transmitted in the synchronized state and their total optical power can be maintained constant at the transmitting end. Therefore, sufficient crosstalk suppression effect can be obtained in, for example, the forward-pumping configuration (in which maximum Raman amplification effect is obtained at the transmitting end).

The optical signal generating means may be configured to include: an inverter circuit for inverting the main signal as an electric signal; a first light source for generating light having a certain wavelength; a second light source for generating light having a wavelength different from that of the light generated by the first light source; a first modulator for modulating the light from the first light source using the main signal; and a second modulator for modulating the light from the second light source using the output of the inverter circuit.

By such composition of the optical signal generating means, a main signal and an inversion signal as optical signals can be obtained by inverting the electric main signal before being inputted to the modulator and modulating the lights from the light sources using the inverted electric main signal and the electric main signal before inversion. In this example, the optical inversion signal can be obtained with slight improvement of the electric circuit, without the need for altering optical parts of an existing optical transmitter, thereby the optical transmitter of the present invention can be implemented very easily.

As another mode for obtaining the main signal and inversion signal as optical signals, the optical signal generating means may include: a first light source for generating light having a certain wavelength; a second light source for generating light having a wavelength different from that of the light generated by the first light source; a first modulator for modulating the light from the first light source using a main signal as an electric signal; a second modulator for modulating the light from the second light source using the main signal as an electric signal; and a modulation status control circuit for controlling the modulation statuses of the first and second modulators so that the main signal as an optical signal will be outputted by one of the first and second modulators and the inversion signal as an optical signal will be outputted by the other of the first and second modulators.

By such composition of the optical signal generating means, the main signal and inversion signal as optical signals can be obtained only by controlling the modulation statuses of the modulators. In this example, cost reduction and miniaturization of the optical transmitter become possible since the above inverter circuits for inverting electric signals are unnecessary. Further, delay occurring between the main signal and the inversion signal due to the difference of electric signal path (whether or not the signal passes the inverter circuit, etc.) can be avoided (that is, the main signal and inversion signal as optical signals can be obtained in a more synchronized state).

As yet another mode for obtaining the main signal and inversion signal as optical signals, the optical signal generating means may include: an optical multiplexer for multiplexing the main signal as an optical signal and a DC (Direct Current) signal as an optical signal; and a semiconductor optical amplifier to which the output of the optical multiplexer is inputted.

By such composition of the optical signal generating means, the main signal and inversion signal as optical signals can be obtained employing the fact that the power of the optical DC signal is modulated according to the waveform of the main signal due to the intrinsic crosstalk characteristics of the semiconductor optical amplifier (that is, employing the semiconductor optical amplifier as a modulator).

Therefore, also in this example, the need to electrically invert the main signals is eliminated, and only one semiconductor optical amplifier functioning as a modulator is necessary, thereby facilitating cost reduction and miniaturization. Further, no delay occurs between the main signal and the inversion signal in this example. Furthermore, the example can also be built up without light sources since input light can directly be used as the input without transforming into an electric signal.

In the optical signal generating means described before, the optical path length from the first modulator to the wavelength division multiplexing means may be set equal to the optical path length from the second modulator to the wavelength division multiplexing means. By such composition, the main signal and the inversion signal can be wavelength division multiplexed with no differential delay between them. Therefore, the two signals can be wavelength division multiplexed and transmitted certainly in a synchronized state and thereby the crosstalk suppression effect can be maximized.

The optical signal generating means may be provided with a variable attenuator for controlling the output level of each modulator. By such composition, optical levels (power) of the main signal and the inversion signal can be adjusted independently, and the total power of the main signal and inversion signal can be controlled and optimized so as to maximize the crosstalk suppression effect.

It is also possible to let the optical signal generating means include an optical coupler for coupling the outputs of the first and second modulators and set the optical path length from the first modulator to the optical coupler equal to the optical path length from the second modulator to the optical coupler.

Also by such composition, the main signal and the inversion signal can be coupled together with no differential delay between them. Therefore, the two signals can be transmitted with certainty in a synchronized state and thereby the crosstalk suppression effect can be maximized. Further, since the distances from the modulators to the optical coupler can be set short, the multiplexing of the main signal and inversion signal maintaining synchronization can be carried out more easily and the circuit design can be made easier.

In this example, by providing a variable attenuator for controlling the output level of the optical coupler, the total power of the main signal and inversion signal can be controlled optimally so as to maximize the crosstalk suppression effect, with a lesser number of variable attenuators compared to the aforementioned example in which the output level of each optical modulator is adjusted independently.

The wavelength division multiplexing means may be implemented by use of an optical multiplexer whose pass band per channel covers the different wavelengths, by which optical signals (each of which include a plurality of wavelengths) can be multiplexed further.

The optical signal generating means may include: a transmission rate conversion unit for carrying out transmission rate conversion to the main signal and thereby obtaining a pair of signals of reduced transmission rate; and a selection unit for selecting a pair of signals composed of the main signal and the output of the inverter circuit or the pair of signals outputted by the transmission rate conversion unit and inputting the selected signals to the first and second modulators respectively.

By such composition, an optical transmitter with high value added, capable of adapting to diverse characteristics of various optical transmission lines and meeting customers' requests, can be provided. A transmission mode reducing the transmission rate by the transmission rate conversion can be used when suppression of waveform deterioration is difficult due to high dispersion or when the transmission of high-bit-rate signals is difficult due to high nonlinearity, and a transmission mode suppressing the crosstalk employing the inversion signal can be used when there is a need to cope with long transmission distances.

The first and second modulators may be composed as a Mach-Zehnder optical modulator/multiplexer which multiplexes the outputs of different output ports of two Mach-Zehnder optical modulators. In this case, the modulators can be implemented in very simple composition, and implementation on a circuit board by means of integration becomes possible, effectively contributing to cost reduction and miniaturization of the optical transmitter.

The optical signal generating means may include a timing control circuit for controlling output timing of the main signal and the inversion signal. By such composition, the differential delay between the main signal and the inversion signal can be adjusted properly and constantly, thereby the change of the differential delay caused by temperature variation, secular change, etc. can be compensated for and adjusted adequately and the differential delay can be optimized even when the crosstalk suppression effect cannot be maximized by letting the main signal and inversion signal be transmitted in the synchronized state, by which the crosstalk suppression effect can constantly be achieved to the maximum.

Another optical transmitter in accordance with the present invention comprises: a plurality of light sources for generating lights of different wavelengths; a plurality of modulators which are provided corresponding to the light sources, each of which modulate the light from the corresponding light source using a main signal to be transmitted; a plurality of optical couplers each of which couples the outputs of the modulators corresponding to at least two adjacent wavelengths; a plurality of variable attenuators for controlling the output levels of the optical couplers; and an optical multiplexer for multiplexing the outputs of the variable attenuators.

In the above optical transmitter (taking advantage of the fact that the difference in transmission loss between adjacent wavelengths is negligible and the output levels of the adjacent wavelengths can be controlled in a lump), the variable attenuator is not provided to each modulator but the variable attenuator is designed to control the output level after the paired signals of adjacent wavelengths have been coupled. By such composition, the number of necessary variable attenuators can be reduced and the circuit for controlling the variable attenuators can be scaled down, thereby overall cost reduction becomes possible and stability can be improved.

An optical repeater in accordance with the present invention, which is provided in order to repeat an optical signal transmitted by an optical transmitter that transmits a main signal to be transmitted and its inversion signal as a wavelength division multiplexed optical signal containing optical signals of different wavelengths corresponding to the main signal and the inversion signal, comprises a dispersion compensator for compensating for wavelength dispersion of the main signal and the inversion signal.

By the optical repeater of the present invention, the differential delay (dispersion) between the main signal and inversion signal of different wavelengths, which accumulates as the transmission distance gets longer due to the wavelength dispersion property of the optical transmission line, can be compensated for by use of the dispersion compensator, by which the crosstalk suppression effect can be achieved to the maximum even in long-distance signal transmission.

An optical receiver in accordance with the present invention, which is provided in order to receive an optical signal transmitted by an optical transmitter that transmits a main signal to be transmitted and its inversion signal as a wavelength division multiplexed optical signal containing optical signals of different wavelengths corresponding to the main signal and the inversion signal, comprises: a quality monitoring unit for monitoring the quality of the main signal and the inversion signal; and a selection unit for selecting the main signal or the inversion signal as a received signal depending on the result of quality monitoring by the quality monitoring unit.

Using the optical receiver of the present invention, a signal (wavelength) having better quality can be selected as the working channel based on the quality monitoring result by the quality monitoring unit, thereby obtaining reliability similar to that of a duplex system (redundant system) as well as ensuring superior transmission characteristics with the crosstalk suppression effect.

Another optical receiver in accordance with the present invention, which is provided in order to receive an optical signal transmitted by an optical transmitter that transmits a main signal to be transmitted and its inversion signal as a wavelength division multiplexed optical signal containing optical signals of different wavelengths corresponding to the main signal and the inversion signal, comprises: an optical demultiplexer for demultiplexing the wavelength division multiplexed optical signal and obtaining the main signal and the inversion signal; and a differential amplifier to which the main signal and the inversion signal from the optical demultiplexer are inputted.

With the optical receiver, the DC (direct current) component of transmission line noise that has been added to the WDM optical signal (main signal, inversion signal) can be canceled out by the differential amplifier, thereby higher signal-to-noise ratio and longer transmission distance can be realized.

Incidentally, as the aforementioned “different wavelengths”, adjacent wavelengths may preferably be used, by which negative effect of wavelength-dependent transmission loss in the optical transmission line can be reduced more effectively compared to cases where wavelengths that are not adjacent are used. For example, the optical signals of different wavelengths can be regarded as an optical signal of one wavelength and transmission power can be controlled in a lump, thereby the optical transmission power control can be simplified, greatly contributing to the miniaturization of the optical transmitter.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing the composition of a WDM (Wavelength Division Multiplex) optical transmission system in accordance with an embodiment of the present invention;

FIG. 2 is a block diagram showing the composition of an optical multiplexing unit of a transmitting station which is shown in FIG. 1;

FIG. 3 is a block diagram showing two light sources and modulators of the optical multiplexing unit of FIG. 2 for generating a pair of optical signals;

FIG. 4(A) is a schematic diagram showing an example of the arrangement of wavelengths (channels) of Raman pump light, a signal to be transmitted and its inversion signal according to the embodiment;

FIG. 4(B) is a schematic diagram showing an example of the waveforms of the Raman pump light, the signal to be transmitted and the inversion signal according to the embodiment before Raman amplification;

FIG. 4(C) is a schematic diagram showing an example of the waveforms of the Raman pump light, the signal to be transmitted and the inversion signal according to the embodiment after Raman amplification;

FIG. 5 is a block diagram for explaining a first modification of an inversion signal generation method according to the embodiment;

FIG. 6 is a schematic diagram for explaining a bias control method for modulators which are shown in FIG. 5;

FIG. 7 is a block diagram for explaining a second modification of the inversion signal generation method according to the embodiment;

FIG. 8 is a block diagram for explaining a third modification of the inversion signal generation method according to the embodiment;

FIG. 9 is a block diagram showing a first modification of the optical multiplexing unit shown in FIGS. 1 and 2;

FIG. 10 is a block diagram for explaining that the optical multiplexing unit of FIG. 9 can also be employed for a conventional WDM optical transmission system;

FIG. 11 is a block diagram showing a second modification of the optical multiplexing unit shown in FIGS. 1 and 2;

FIG. 12 is a block diagram showing the composition of an EDFA (Erbium Doped Fiber Amplifier) shown in FIG. 1;

FIG. 13 is a schematic diagram showing an example of pass band characteristics of the optical multiplexing unit shown in FIG. 9 (or FIG. 10);

FIG. 14 is a block diagram showing the composition of an optical demultiplexing unit of a receiving station which is shown in FIG. 1;

FIG. 15 is a block diagram showing a first modification of the optical demultiplexing unit shown in FIG. 1;

FIG. 16 is a block diagram showing a second modification of the optical demultiplexing unit shown in FIG. 1;

FIG. 17 is a block diagram showing a first modification of the EDFA shown in FIG. 1;

FIG. 18(A) is a block diagram showing a WDM optical transmission system which carries out multistage optical amplification repeating;

FIG. 18(B) is a schematic diagram showing a delay occurring between the transmitted signal and its inversion signal depending on the transmission distance when no DCF (Dispersion Compensating Fiber) is provided to the system shown in FIG. 18(A);

FIG. 18(C) is a schematic diagram showing a delay occurring between the transmitted signal and its inversion signal depending on the transmission distance when a DCF is provided to each repeater station of the system shown in FIG. 18(A);

FIG. 18(D) is a schematic diagram showing Raman gain by means of Raman amplification of forward-pumping in the system shown in FIG. 18(A), which changes depending on the transmission distance;

FIG. 19 is a schematic diagram for explaining a method for controlling delay between the signal to be transmitted and its inversion signal according to the embodiment;

FIGS. 20(A) and 20(B) are schematic diagrams for explaining a case where three wavelengths are used for the transmission of the signal to be transmitted and its inversion signal according to the embodiment;

FIG. 21 is a block diagram showing an example of a conventional WDM optical transmission system employing an EDFA and a Raman amplifier in combination;

FIG. 22 is a schematic diagram for explaining repeating gain and spontaneous emission noise in a conventional WDM optical transmission system employing an EDFA and a Raman amplifier in combination;

FIGS. 23(A) and 23(B) are schematic diagrams for explaining a modulation effect on Raman pump light during Raman amplification;

FIG. 24(A) is a schematic diagram showing an example of the arrangement of wavelengths (channels) of Raman pump light and two signals to be transmitted;

FIG. 24(B) is a schematic diagram showing an example of the waveforms of the Raman pump light and the two signals to be transmitted shown in FIG. 24(A) before Raman amplification;

FIG. 24(C) is a schematic diagram showing an example of the waveforms of the Raman pump light and the two signals to be transmitted shown in FIG. 24(A) after Raman amplification;

FIG. 25(A) is a block diagram showing the composition of a Raman amplifier of a forward-pumping type;

FIG. 25(B) is a block diagram showing the composition of a Raman amplifier of a backward-pumping type;

FIG. 25 (C) is a block diagram showing the composition of a Raman amplifier of a bidirectional-pumping type;

FIGS. 26(A) through 26(C) are schematic diagrams for explaining “pattern effect” of a semiconductor optical amplifier; and

FIGS. 27(A) through 27(E) are schematic diagrams for explaining “inter-channel crosstalk” of a semiconductor optical amplifier which is caused by the “pattern effect”.

### BEST MODE FOR CARRYING OUT THE INVENTION

Referring now to the drawings, a description will be given in detail of a preferred embodiment in accordance with the present invention.

(A) Explanation on an Embodiment

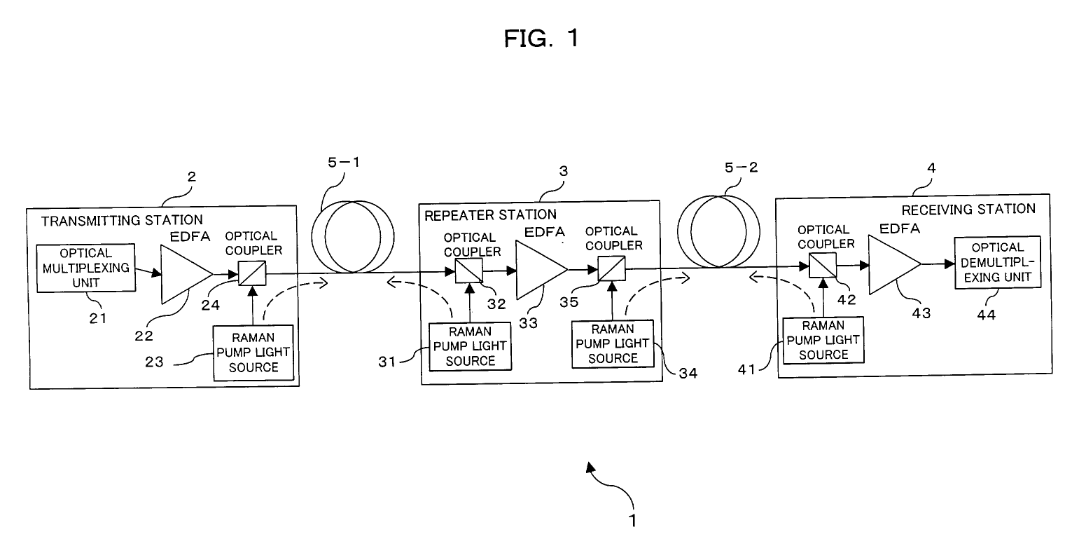

FIG. 1 is a block diagram showing the composition of a WDM (Wavelength Division Multiplex) optical transmission system in accordance with an embodiment of the present invention. The WDM optical transmission system 1 of FIG. 1 includes a transmitting station (optical transmitter) 2, a repeater station (optical repeater) 3 which is connected to the transmitting station 2 via an optical (fiber) transmission line 5-1, and a receiving station (optical receiver) 4 which is connected to the repeater station 3 via an optical (fiber) transmission line 5-2. While the WDM optical transmission system 1 of FIG. 1 includes only one repeater station 3, the number of repeater stations 3 can also be set to two or more or zero, depending on the transmission distance.

As shown in FIG. 1, the transmitting station 2 includes an optical multiplexing unit 21, an EDFA (Erbium Doped Fiber Amplifier) 22, a Raman pump light source 23 and an optical coupler 24. The repeater station 3 includes Raman pump light sources 31 and 34, optical couplers 32 and 35, and an EDFA 33. The receiving station 4 includes a Raman pump light source 41, an optical coupler 42, an EDFA 43 and an optical demultiplexing unit 44.

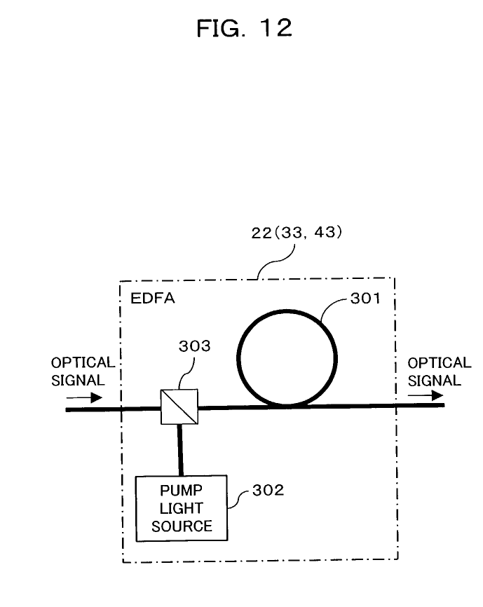

In the transmitting station 2, the optical multiplexing unit 21 generates a WDM signal to be transmitted to the receiving station 4. The EDFA 22 amplifies the WDM signal of a particular wavelength band (e.g. 1.55 μm band) which is supplied from the optical multiplexing unit 21, by a preset gain or amplification factor. FIG. 12 shows an example of the composition of the EDFA 22, in which the EDFA 22 includes an EDF (rare-earth doped optical fiber) 301, a pump light source 302 for generating pump light for the EDF 301, and an optical coupler 303 for inputting the pump light from the pump light source 302 to the EDF 301. The EDFAs 33 and 43 (which will be explained below) also have the composition shown in FIG. 12.

The Raman pump light source 23 generates pump light (for forward-pumping) having a wavelength suitable for letting the optical fiber transmission line 5-l carry out Raman amplification in the same wavelength band as that of the EDFA 22 (hereafter, also referred to as “Raman pump light”). The optical coupler 24 couples the output of the EDFA 22 with the Raman pump light from the Raman pump light source 23 and outputs the coupled signal/light to the optical fiber transmission line 5-1. The optical coupler 24 can be implemented by an arrayed waveguide grating filter, for example.

In the repeater station 3, the Raman pump light source 31 on the input side generates Raman pump light (for backward-pumping) having a wavelength suitable for letting the optical fiber transmission line 5-1 carry out Raman amplification in the same wavelength band as that of the EDFA 22. The optical coupler 32 on the input side inputs the Raman pump light from the Raman pump light source 31 to the optical fiber transmission line 5-1. The EDFA 33, an amplifier similar to the EDFA 22 of the transmitting station 2, amplifies the WDM signal supplied from the optical fiber transmission line 5-1 through the optical coupler 32, by a preset gain or amplification factor.

On the other hand, the Raman pump light source 34 on the output side generates Raman pump light (for forward-pumping) having a wavelength suitable for letting the optical fiber transmission line 5-2 carry out Raman amplification in the same wavelength band as those of the EDFAs 22 and 33. The optical coupler 35 on the output side couples the output of the EDFA 33 with the Raman pump light from the Raman pump light source 34 and outputs the coupled signal/light to the optical fiber transmission line 5-2.

In the receiving station 4, the Raman pump light source 41 generates Raman pump light (for backward-pumping) having a wavelength suitable for letting the optical fiber transmission line 5-2 carry out Raman amplification in the same wavelength band as those of the EDFAs 22 and 33. The optical coupler 42 inputs the Raman pump light from the Raman pump light source 41 to the optical fiber transmission line 5-2.

The EDFA 43, an amplifier similar to the EDFAs 22 and 33, amplifies the WDM signal supplied from the optical fiber transmission line 5-2 through the optical coupler 42, by a preset gain or amplification factor. The optical demultiplexing unit 44 demultiplexes the output of the EDFA 43 (WDM signal) into optical signals of different wavelengths (which have been wavelength division multiplexed) and carries out necessary reception processes for each optical signal of each wavelength.

In short, the WDM optical transmission system 1 (hereafter, also abbreviated as “system 1”) of this embodiment has a hybrid composition, in which the aforementioned Raman amplification of the bidirectional-pumping type is applied to an optical repeating transmission system employing EDFAs 22, 33 and 43.

By the above composition of the system 1, the WDM signal generated by the optical multiplexing unit 21 of the transmitting station 2 is amplified (common amplification) by the EDFA 22, coupled by the optical coupler 24 with the Raman pump light from the Raman pump light source 23, and transmitted to the optical fiber transmission line 5-1.

The repeater station 3 carries out, in addition to the amplification by the EDFA 33, Raman amplification of the bidirectional-pumping using the optical fiber transmission lines 5-1 and 5-2 as amplification mediums, by letting the Raman pump light sources 31 and 34 output Raman pump light to the optical fiber transmission lines 5-1 and 5-2 respectively. In this case, the Raman amplification is driven under specific conditions to have gain in the same wavelength band as those of the EDFAs 22 and 33.

The receiving station 4 similarly carries out Raman amplification to the WDM signal transmitted through the optical fiber transmission line 5-2, by letting the optical coupler 42 input the Raman pump light from the Raman pump light source 41 to the optical fiber transmission line 5-2. Thereafter, the WDM signal which has been Raman-amplified and received by the receiving station 4 is pre-amplified by the EDFA 43 and demultiplexed/received by the optical demultiplexing unit 44.

The optical level of the WDM signal transmitted by the transmitting station 2 as above decreases during signal transmission, according to transmission loss characteristics of the optical fiber transmission lines 5-1 and 5-2. However, the WDM signal is Raman-amplified in the optical fiber transmission lines 5-1 and 5-2 (amplification mediums) by the Raman pump light supplied from both directions, thereby optical input levels to the repeater station 3 and receiving station 4 get far higher compared to cases where no Raman amplification is employed (and higher compared to cases where either forward-pumping or backward-pumping is employed).

Consequently, gains that are required of the EDFAs 22, 33 and 43 can be reduced significantly, and the repeating distance of the WDM signal under the same optical transmission conditions can be extended dramatically since Raman amplification is “distributed constant”-like amplification having superior low-noise characteristics as mentioned before.

In cases where Raman amplification of the bidirectional-pumping type is conducted as above, that is, when Raman amplification of the forward-pumping type is necessary, “inter-channel crosstalk” becomes a problem as mentioned before.

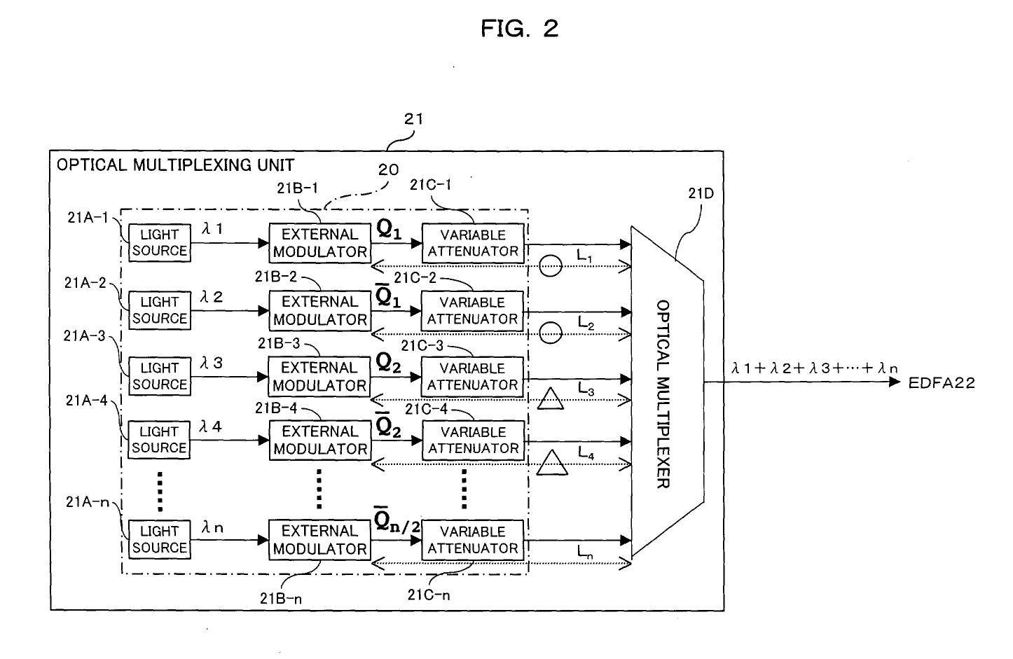

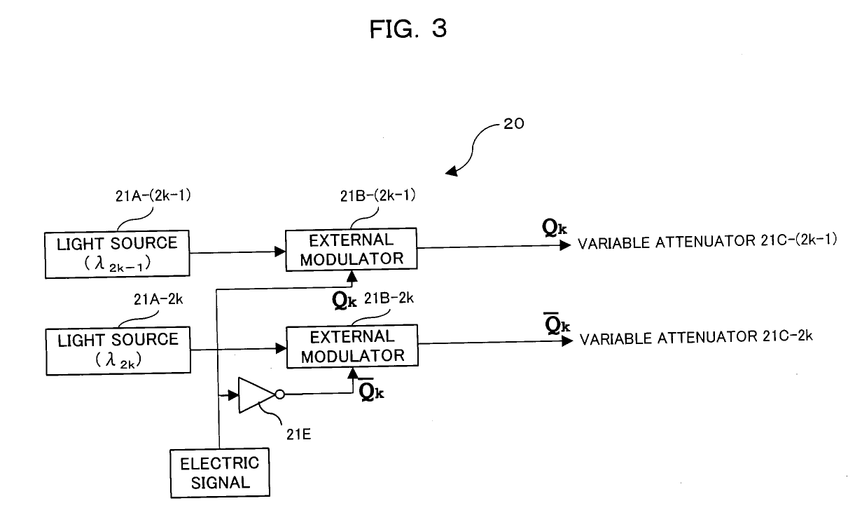

In order to resolve the problem, the optical multiplexing unit 21 in this embodiment is provided with light sources 21A-1 to 21A-n, modulators (external modulators) 21B-1 to 21B-n and variable attenuators 21C-1 to 21C-n corresponding to wavelengths λ1 to λn (n: positive even number (16, 32, 64, 128, etc.)) and an optical multiplexer 21D as shown in FIG. 2 for example, and an inverter gate (inverter circuit) 21E is provided to each pair of modulators 21B-(2k−1) and 21B-2k (k=1 to n/2) corresponding to two adjacent wavelengths λ₂ₖ₋₁ and λ₂ₖ as shown in FIG. 3.

Each light source 21A-i (i=1 to n) for generating an optical signal (light) of a wavelength λi is implemented by, for example, a semiconductor laser. As a matter of course, the wavelengths λ1 to λn are wavelength bands that are contained in the amplification wavelength band of the EDFAs 22, 33 and 43 (e.g. 1.55 μm band). Incidentally, the wavelength λ1 is assumed to be the shortest one of the wavelengths λi in this embodiment.

Each external modulator 21B-i modulates an optical signal (wavelength: λi) supplied from a corresponding light source 21A-i. As shown in FIG. 3, the optical signal (wavelength: λ₂ₖ₋₁) from the (first) light source 21A-(2k−1) is modulated by the (first) external modulator 21B-(2k−1) by use of a main signal (transmission data; electric signal) Qk to be transmitted, and the optical signal (wavelength: λ₂ₖ) from the (second) light source 21A-2k is modulated by the (second) external modulator 21B-2k by use of an inversion signal \overline{Q}k (hereinafter referred to as Qk*) which is obtained by the inverter gate 21E by inverting the waveform of the main signal Qk. Incidentally, each external modulator 2lB-i can be implemented by, for example, the well-known Mach-Zehnder optical modulator as will be explained later.

Each variable attenuator 21C-i, whose attenuance can be adjusted properly, adjusts the output level of a corresponding external modulator 21B-i and thereby adjusts the input level of the optical signal to the optical multiplexer 21D. Specifically, the attenuance of each variable attenuator 21C-i is controlled so as to equalize the input levels of the optical signals to the optical multiplexer 21D. The optical multiplexer (wavelength division multiplexing means) 21D multiplexes the outputs of the variable attenuators 21C-i (n-wavelength multiplexing) and outputs (transmits) the multiplexed signal (WDM signal) to the EDFA 22.

By the above composition of the optical multiplexing unit 21, the optical signals (wavelengths: λ₂ₖ₋₁, λ₂ₖ) from the light sources 21A-(2k−1) and 21A-2k are first modulated by the external modulators 21B-(2k−1) and 21B-2k using the main signal Qk and the inversion signal Qk* respectively.

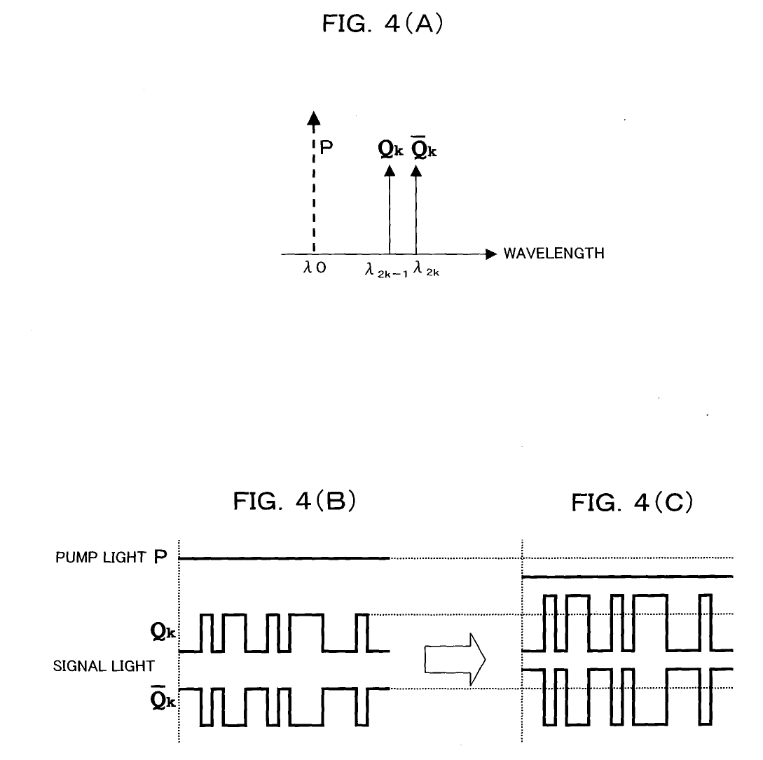

Consequently, an optical signal (wavelength: λ₂ₖ₋₁) carrying the information of the signal Qk is outputted by the external modulator 21B-(2k−1), and an optical signal (wavelength: λ₂ₖ) carrying the information of the inversion signal Qk* (which is obtained by inverting the marks (bit value: “1”) and the spaces (bit value: “0”) of the main signal Qk) is outputted by the external modulator 21B-2k, as schematically shown in FIGS. 4(A) and 4(B).

The optical signals Qk and Qk* (k: 1 to n/2) are inputted to corresponding variable attenuators 21C-i and their optical levels are adjusted and equalized throughout the wavelengths λ1 to λn. Thereafter, the equalized optical signals Qk and Qk* (k: 1 to n/2) are multiplexed (n-wavelength multiplexing) into the WDM signal by the optical multiplexer 21D, and the WDM signal is transmitted to the optical fiber transmission line 5-1 via the EDFA 22 and the optical coupler 24.

In short, the optical multiplexing unit 21 of this embodiment transmits a signal Qk having certain information (or signals Qk and Qk* having the same information) by use of two different wavelengths λ₂ₖ₋₁ and λ₂ₖ (like transmitting a signal Q₁ and its inversion signal Q₁* using wavelengths λ1 and λ2, a signal Q₂ and its inversion signal Q₂* using wavelengths λ3 and λ4, etc.). Therefore, as shown in FIG. 2, the light source 21A-i, the external modulator 21B-i and the variable attenuator 21C-i form an optical signal generation means 20 for generating the signal Qk and the invention signal Qk* as optical signals of two different wavelengths λ₂ₖ₋₁ and λ₂ₖ.

The two optical signals of the wavelengths λ₂ₖ₋₁ and λ₂ₖ propagate through the optical fiber transmission lines 5-1 and 5-2 together with the Raman pump light P (wavelength: λ0) for forward-pumping, as schematically shown in FIGS. 4(A) and 4(B). In this case, if we assume that the two optical signals (wavelengths: λ₂ₖ₋₁, λ₂ₖ) propagate maintaining their synchronization almost perfectly, the total power of the optical signals of the wavelengths λ₂ₖ₋₁ and λ₂ₖ becomes almost constant as schematically shown in FIG. 4(C).

As a result, the energy of the Raman pump light P that is consumed by the signals Qk and Qk* during Raman amplification becomes constant as shown in FIG. 4(C), thereby the modulation effect on the Raman pump light P is reduced and the “inter-channel crosstalk” which stands out in the forward-pumping can be suppressed effectively.

Here, let us estimate the phase shift (differential delay) between the signals Qk and Qk* which is caused by wavelength dispersion of the optical fiber transmission lines 5-1 and 5-2 as Raman amplification mediums. Assuming that dispersion shift fibers or non-zero dispersion fibers are employed, the optical fiber transmission lines 5-1 and 5-2 would have dispersion of approximately 1 ps/km/nm.

Therefore, if we assume that the interval between adjacent channels (wavelengths) is 1 nm and the transmission distance is 100 km (kilometers), the shift or delay between the signals Qk and Qk* caused by the above dispersion amounts to 100 ps. The differential delay (shift) corresponds to one time slot of a 10 Gbps signal or a transmission length of approximately 3 cm (centimeters).

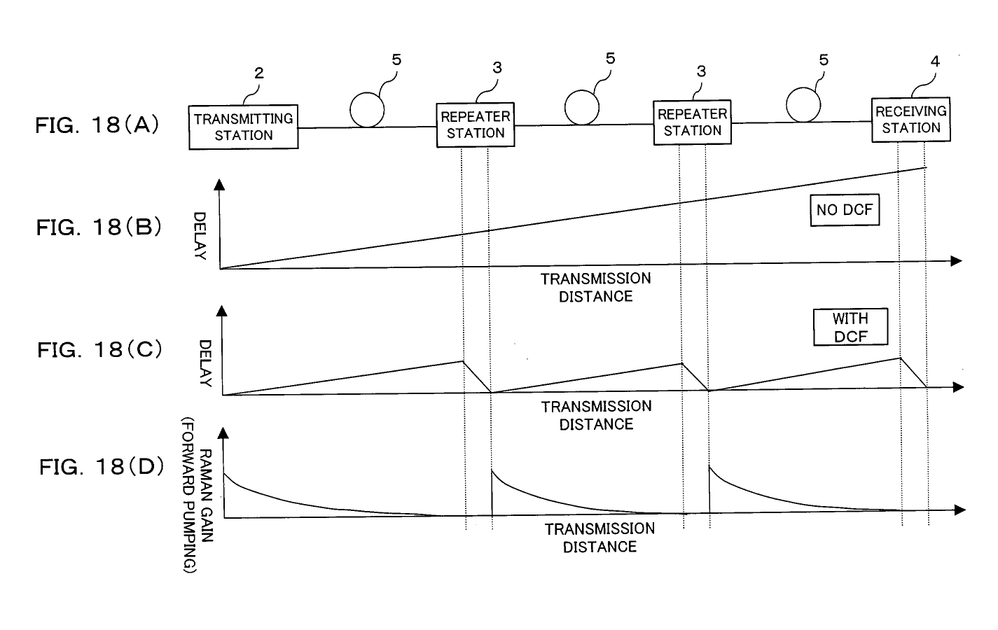

However, as schematically shown in FIG. 18(D), the Raman amplification effect of the forward-pumping takes place almost in the vicinity of the transmitting end, therefore, the synchronization between the signals Qk and Qk* is maintained sufficiently nearby the transmitting end and the crosstalk can be suppressed effectively.

However, synchronization can not be attained at all even at the transmitting end if there exists an optical path difference of one time slot or 3 cm before the signals Qk and Qk* are coupled together or multiplexed. Therefore, in the transmitting station 2, it is at least necessary to let the optical multiplexer 21D wavelength division multiplex the two signals Qk and Qk* maintaining phase synchronization or phase coherence.

Therefore, in this embodiment, the lengths (or placement) of optical paths from the external modulators 21B-i to the optical multiplexer 21D are designed so that at least the optical path length L₂ₖ₋₁ from the external modulator 21B-(2k−1) to the optical multiplexer 21D will be equal to the optical path length L₂ₖ from the external modulator 21B-2k to the optical multiplexer 21D. In other words, the optical path lengths are set so that the paired external modulators 21B-(2k−1) and 21B-2k will have the same optical path length to the optical multiplexer 21D, as shown with a mark ◯ and a mark Δ in FIG. 2. Of course, it is also possible to set equal optical path lengths to all the external modulators 21B-i.

By the above composition, the pair of signals Qk and Qk* can be coupled together and transmitted by the optical multiplexer 21D in a phase-coherent state, and with the improvement of the characteristics of the optical multiplexing unit 21 (transmitting station 2), the inter-channel crosstalk suppression effect can be maximized.

As described above, by the transmitting station 2 in accordance with the embodiment of the present invention, an inversion signal Qk* as the inversion of a signal Qk to be transmitted is generated and the signals Qk and Qk* are transmitted using two adjacent wavelengths λ₂ₖ₋₁ and λ₂ₖ and maintaining synchronization, thereby the “inter-channel crosstalk” occurring intensely in the Raman amplification by forward-pumping can be suppressed effectively, independently of the performance/characteristics of optical devices. As a result, long-distance transmission for twice the conventional transmission distance or more is made possible.

Therefore, when the transmission distance is predetermined and fixed, the number of repeater stations necessary for the system 1 can be reduced considerably and costs for the system 1 can be cut down compared to conventional systems. When the number of repeater stations is fixed, the transmission distance can be extended, and a system 1 capable of long-distance transmission for twice the conventional transmission distance or more can be constructed.

Further, in this embodiment, the (electric) inversion signal Qk* is obtained by electrically inverting the (electric) signal Qk to be transmitted by use of the inverter gate 21E, and the optical inversion signal is obtained by modulating the optical signal (light) of the wavelength λ₂ₖ using the inversion signal Qk* as explained above referring to FIG. 3. Therefore, the transmitting station 2 (optical transmitter) of this embodiment can be implemented easily, since the optical inversion signal can be obtained with slight improvement of the electric circuit of the optical transmitter, without the need of altering the basic composition or optical parts of the existing optical transmitter.

Further, as the variable attenuator 21C-i is provided between the external modulator 21B-i and the optical multiplexer 21D, the optical level (power) of each signal (Qk, Qk*) can be adjusted independently, and it is possible to adjust the total power of the signals Qk and Qk* to the optimum state in which the inter-channel crosstalk suppression effect is maximized.

There may be some apprehension that this embodiment, using two wavelengths λ₂ₖ₋₁ and λ₂ₖ for one signal Qk having a piece of information (or two signals Qk and Qk* having the same information), might not be profitable since only half of the wavelength band can be used effectively in comparison with conventional techniques in which one wavelength is assigned to one signal. In the following, consideration will be given to this point.

In WDM optical transmission, there are two ways of increasing the multiplicity (i.e. the number of wavelengths that can be multiplexed): widening the amplification bandwidth of the optical amplifiers; and narrowing the interval between adjacent wavelengths. As for the wavelength interval, existing devices mainly employ a 100 GHz (gigahertz) interval for example, and it appears that the multiplicity will be increased further in next-generation devices by narrowing the wavelength interval to ½ (50 GHz interval) or ¼ (25 GHz interval).

Therefore, as a way to realize the long-distance transmission by suppressing the “inter-channel crosstalk” employing the above method of the embodiment (using two wavelengths λ₂ₖ₋₁ and λ₂ₖ for the signals Qk and Qk* having the same information) while preventing the multiplicity from decreasing, narrowing the wavelength interval further seems to be feasible. So let us consider to what extent the wavelength interval can be narrowed.

Factors limiting or deteriorating the transmission characteristics when the wavelength interval is narrowed can be classified into “linear crosstalk” and “nonlinear crosstalk”. The linear crosstalk, which may be caused by power leak-in etc. from adjacent channels in the multiplexer/demultiplexer, occurs whether the method of the embodiment is employed or not.

On the other hand, the nonlinear crosstalk is caused not only by the aforementioned Raman amplification but also by self phase modulation (SPM), cross phase modulation (XPM) and four-wave mixing (FWM). Here, if we assume the wavelength interval between the signals Qk and Qk* is narrowed limitlessly, the two signals Qk and Qk* can be regarded as being carried by virtually one wavelength. In this case, the total power of the signals Qk and Qk* can almost be regarded as DC (direct current) power, and thus the crosstalk from the signals Qk and Qk* (carried by virtually one wavelength) to other channels also becomes DC-like.

Therefore, the method of the embodiment is expected to serve also for the suppression of the nonlinear crosstalk caused by SPM, XPM, FWM, etc. Further, if the wavelength interval is narrowed limitlessly, it is expected that the phase shift between the signals Qk and Qk* caused by wavelength dispersion also decreases proportionally and the crosstalk suppression effect is enhanced.

To sum up, it is expected that an optical transmission system capable of transmitting signals for longer distance with lower noise can be realized more easily by the method of this embodiment (alternately assigning the signals Qk and their inversion signals Qk* to adjacent wavelengths and wavelength division multiplexing the optical signals of the wavelengths alternately carrying the signals Qk and Qk*) rather than by increasing the wavelength multiplicity within the conventional technology (letting the wavelengths carry different and independent signals).

(B) First Modification of Inversion Signal Generation Method

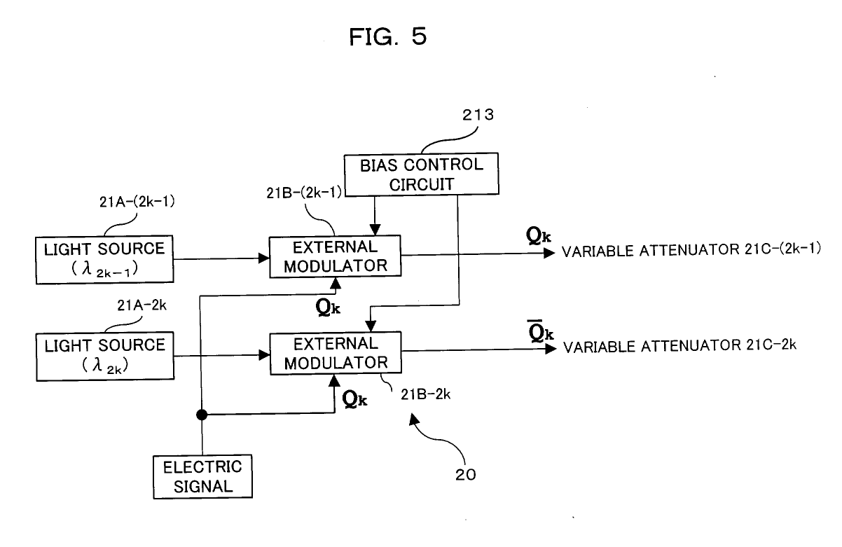

The circuit of FIG. 3 (optical signal generation means 20) can be replaced by the composition shown in FIG. 5. In the example of FIG. 5, a bias control circuit 213 is provided to each pair of the external modulators 21B-(2k−1) and 21B-2k, and the same electric signal Qk is inputted to the external modulators 21B-(2k−1) and 21B-2k without using the inverter gate 21E.

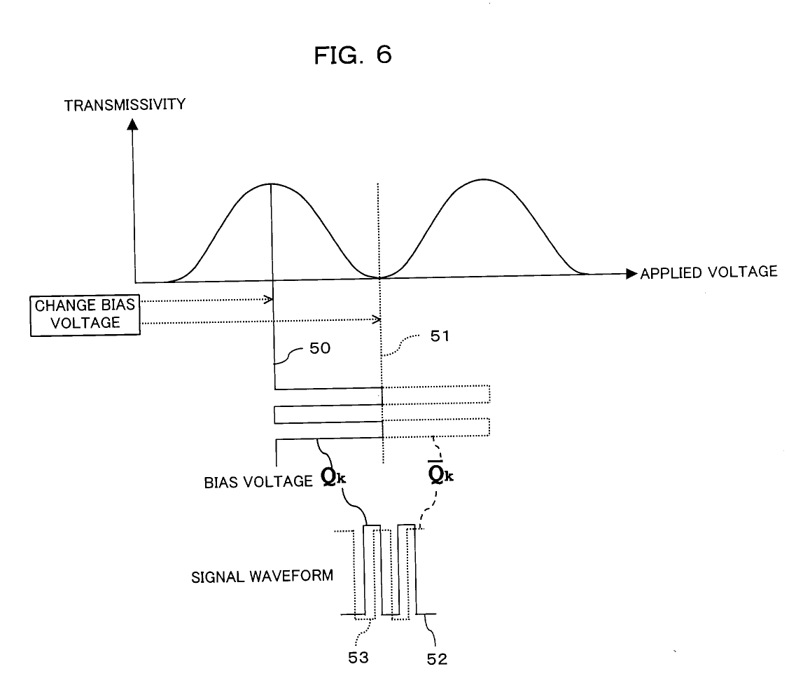

As shown in FIG. 6, the bias control circuit 213 controls bias voltages which are applied to the external modulators 21B-(2k−1) and 21B-2k (unshown electrodes provided to optical waveguides for the signals Qk) and thereby adjusts the optical transmissivity of the optical waveguides properly so that the signal Qk (solid line 52) will be outputted by the output port of the external modulator 21B-(2k−1) and the inversion of the signal Qk* (broken line 53) will be outputted by the output port of the other external modulator 21B-2k.

Specifically, the solid line 50 and broken line 51 shown in FIG. 6 indicate the bias voltages which are applied to the external modulators 21B-(2k−1) and 21B-2k respectively.

In short, the bias control circuit 213 functions as a modulation status control circuit for controlling the modulation statuses of the external modulators 21B-(2k−1) and 21B-2k so that the signal Qk (as an optical signal) will be outputted by the external modulator 21B-(2k−1) and the inversion signal Qk* (as an optical signal) will be outputted by the other external modulator 21B-2k.

In this example, the inversion signals Qk* can be obtained without the need of electrically inverting the (electric) signals Qk (that is, without the need of the inverter gates 21E), by which cost reduction and miniaturization become possible. Further, delay occurring between the signals Qk and Qk* due to the difference of electric signal path (whether or not the signal passes the inverter gate 21E, etc.) can be avoided and thereby the transmission of the signals Qk and Qk* can be conducted in a more synchronized state.

(C) Second Modification of Inversion Signal Generation Method

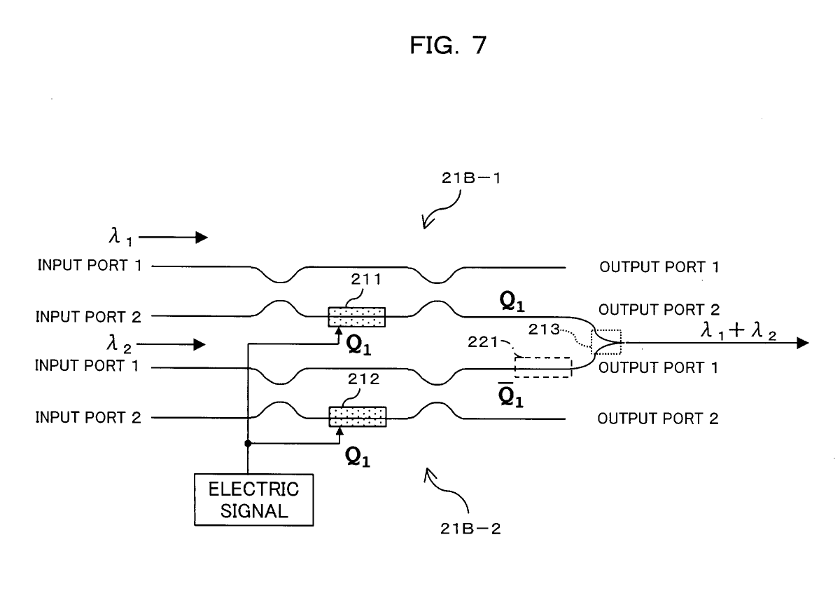

The circuit of FIG. 3 (optical signal generation means 20) can also be replaced by the composition shown in FIG. 7. In the example of FIG. 7, the external modulators 21B-(2k−1) and 21B-2k are implemented by two Mach-Zehnder optical modulators which are placed in parallel. Two optical signals (having different wavelengths λ₂ₖ₋₁, λ₂ₖ) supplied from the light sources 21A-(2k−1) and 21A-2k are inputted to the same input ports (input ports “1” in FIG. 7) of the two Mach-Zehnder optical modulators respectively, and the (electric) signal Q to be transmitted is applied to electrodes 211 and 212 of the Mach-Zehnder optical modulators as the modulation signal. Incidentally, composition corresponding to only two external modulators 21B-1 and 21B-2 (for two wavelengths λ1 and λ2) is shown in FIG. 7 as a representative example.

By the above composition, the signal Q₁ and its inversion signal Q₁* can be obtained from opposite output ports of the Mach-Zehnder optical modulators (the output port “2” of the external modulator 21B-1 and the output port “1” of the external modulator 21B-2 in FIG. 7). Incidentally, the operation and function of the Mach-Zehnder optical modulator itself have become publicly known.

Further, as shown with the dotted line in FIG. 7, by letting an optical multiplexer 213 multiplex the two signals Qk and Qk* (from the output port “2” of the external modulator 21B-1 and the output port “1” of the external modulator 21B-2), the external modulators 21B-1 and 21B-2 and the optical multiplexer 213 can be integrated into a Mach-Zehnder optical modulator/multiplexer on a circuit board.

As above, by employing Mach-Zehnder optical modulators as the external modulators 21B-(2k−1) and 21B-2k, the modulators 21-i necessary for the transmitting station 2 can be implemented more simply and in small sizes, thereby the optical multiplexing unit 21 (and the transmitting station 2 as well) can be miniaturized considerably. Further, by use of the optical multiplexer 213, the differential delay occurring between the signals Qk and Qk* can be minimized and the inter-channel crosstalk suppression effect can be enhanced.

(D) Third Modification of Inversion Signal Generation Method

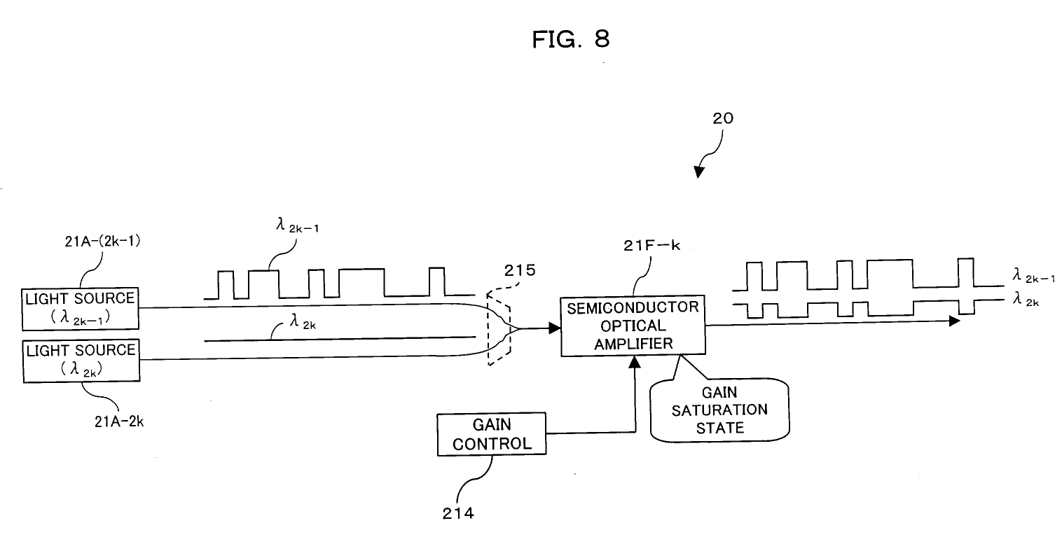

As another way to obtain the inversion signals Qk* by the optical signal generation means 20, it is also possible to use semiconductor optical amplifiers 21F-k (k=1 to n) as shown in FIG. 8. In the example of FIG. 8, an optical signal (wavelength: λ₂ₖ₋₁) from the light source 21A-(2k−1) which has been modulated by the signal to be transmitted is multiplexed with an optical DC (Direct Current) signal (wavelength: λ₂ₖ) from the other light source 21A-2k by an optical multiplexer 215, and the multiplexed optical signal is inputted to the semiconductor optical amplifier 21F-k.

In this case, the light source 21A-(2k−1) functions as a main signal generation circuit for generating the main signal Qk as an optical signal (by means of direct modulation), and the other light source 21A-2k functions as a DC signal generation circuit for generating the DC signal as an optical signal (i.e. optical DC signal).

The semiconductor optical amplifier 21F-k is operated in the gain saturation state under the gain control of a gain control circuit 214, by which the optical DC signal (wavelength: λ₂ₖ) is modulated due to the crosstalk characteristics of the semiconductor optical amplifier 21F-k. In this process, the inversion signal Qk* can be obtained by properly adjusting the gain of the semiconductor optical amplifier 21F-k so that the modulated signal (signal carried by the modulated optical signal) will be the inversion of the signal Qk.

In short, the signal Qk and the inversion signal Qk* as optical signals are obtained employing the fact that the power of the aforementioned optical DC signal is modulated by the semiconductor optical amplifier 21F-k according to the waveform of the signal Qk (that is, employing the semiconductor optical amplifier 21F-k as a modulator).

Therefore, also in this example, the need for electrically inverting the main signals Qk is eliminated, and only one semiconductor optical amplifier functioning as a modulator is necessary for each pair of adjacent wavelengths λ₂ₖ₋₁ and λ₂ₖ, thereby cost reduction and miniaturization become possible. Further, no delay occurs between the signal Qk and the inversion signal Qk* in this example.

Furthermore, the example of FIG. 8 can also be built up without the light sources 21A-i since input light can directly be used as the input without transforming into an electric signal. For example, optical signals handled by an optical cross-connect or ADM (Add-Drop Multiplexer) can directly be used as the input.

(E) First Modification of Optical Multiplexing Unit 21

Next, a first modification of the optical coupling unit 21 of FIG. 2 will be explained.

In the optical multiplexing unit 21 which has been explained referring to FIG. 2, n variable attenuators 21C-i were provided corresponding to the n wavelengths. However, the optical fiber transmission lines 5-1 and 5-2 generally have transmission loss characteristics that are wavelength-dependent. Therefore, when the signal Qk and its inversion signal Qk* are transmitted using adjacent wavelengths λ₂ₖ₋₁ and λ₂ₖ, the difference in the transmission loss in the optical fiber transmission lines 5-1 and 5-2 caused by the wavelength difference between λ₂ₖ₋₁ and λ₂ₖ can be considered negligible.

In other words, the transmission loss to be controlled does not vary much between the adjacent wavelengths λ₂ₖ₋₁ and λ₂ₖ, and characteristics deterioration caused by the control of the optical signals of the adjacent wavelengths λ₂ₖ₋₁ and λ₂ₖ in a lump is considered to be small. Therefore, the optical multiplexing unit 21 is not necessarily required to conduct the attenuance control (optical transmission power control) for each of the adjacent wavelengths λ₂ₖ₋₁ and λ₂ₖ.

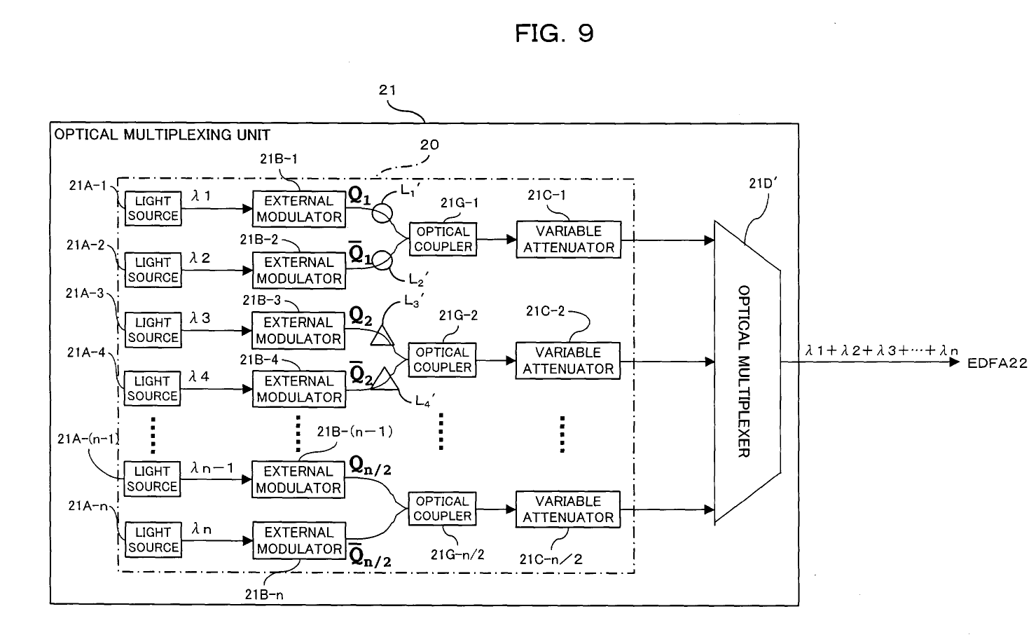

Therefore, in the case where the signal Qk and the inversion signal Qk* are transmitted using adjacent wavelengths λ₂ₖ₋₁ and λ₂ₖ, an optical coupler 21G-k is provided to each pair of modulators 21B-(2k−1) and 21B-2k in the optical signal generation means 20, and the outputs of the modulators 21B-(2k−1) and 21B-2k are immediately coupled together by the optical coupler 21G-k as shown in FIG. 9 for example. The variable attenuator 21C-k carries out optical signal level control for the two wavelengths λ₂ₖ₋₁ and λ₂ₖ in a lump.

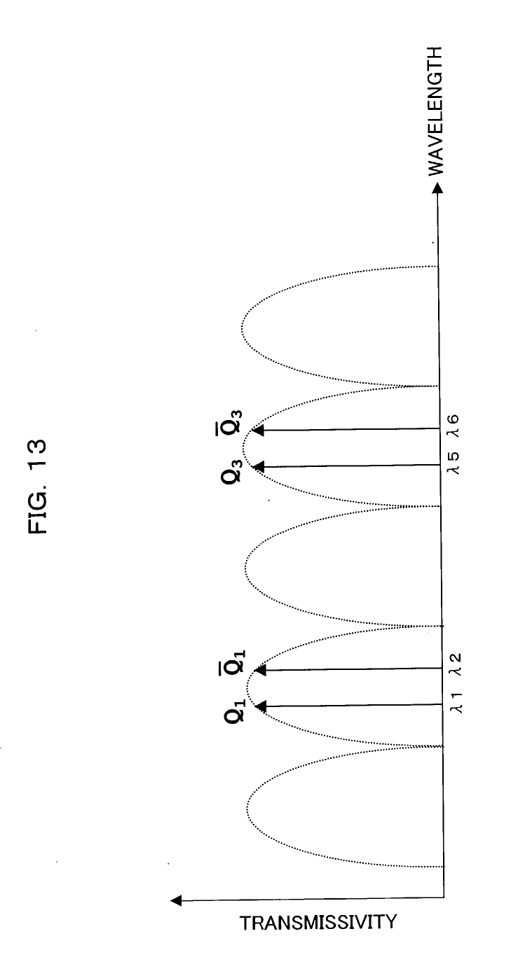

In this case (or when the aforementioned composition of FIG. 7 or FIG. 8 is employed), the output of a variable attenuator 21C-i includes a plurality of (two) wavelengths (channels) λ₂ₖ₋₁ and λ₂ₖ, therefore, an optical multiplexer 21D′ whose pass band for each channel is wider than normal (designed so that its pass band per channel will cover the two wavelengths λ₂ₖ₋₁ and λ₂ₖ) is employed, as schematically shown in FIG. 13. By use of such an optical multiplexer 21D′ , optical signals (each of which include a plurality of wavelengths) can be multiplexed further.

By the above composition, the number of variable attenuators 21C-k can be reduced to half compared to the composition of FIG. 2, and the control of the variable attenuators 21C-k (i.e. optical transmission power control) can be simplified. As a result, the optical multiplexing unit 21 can be miniaturized significantly and the transmitting station 2 can also be downsized considerably.

Also in this example, the optical path length L₂ₖ₋₁′ from the modulator 21B-(2k−1) to the optical coupler 21G-k is set equal to the optical path length L₂ₖ′ from the modulator 21B-2k to the optical coupler 21G-k, as shown with a mark ◯ and a mark Δ in FIG. 9.

By such composition, similarly to a previous example, the pair of signals Qk and Qk* can be coupled together and transmitted by the optical multiplexer 21D′ in a phase-coherent state and the inter-channel crosstalk suppression effect can be maximized. Especially in this example, the distances (optical paths) between the modulators (21B-(2k−1), 21B-2k) and the optical coupler 21G-k (which have to be equalized with each other) are short, by which the phase synchronization of the signals Qk and Qk* can be attained more easily and the circuit design can be made easier.

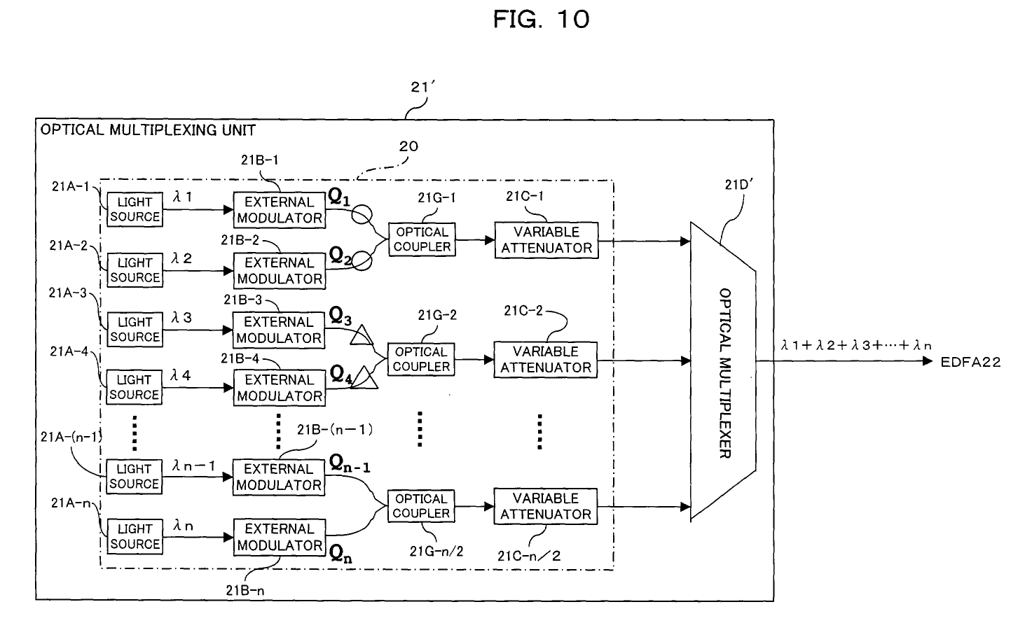

Incidentally, the above composition can also be applied to a transmitting station (optical multiplexing unit 21′) of a conventional WDM optical transmission system in which the wavelengths to be multiplexed carry different and independent signals, as shown in FIG. 10 for example.

Specifically, since the difference in the transmission loss between the adjacent wavelengths λ₂ₖ₋₁ and λ₂ₖ is also slight in the conventional WDM optical transmission system, also in the conventional case where the optical signals from light sources 21A-i are modulated by corresponding modulators 21B-i by use of different signals (transmission data) Q₁ to Qₙ respectively, an optical coupler 21G-k is provided to each pair of modulators 21B-(2k−1) and 2lB-2k and the outputs of the modulators 21B-(2k−1) and 21B-2k are coupled by the optical coupler 21G-k.

By such composition, also in the optical multiplexing unit 21′ employed for a conventional WDM optical transmission system, the optical transmission power of a plurality of channels (wavelengths) can be controlled by half the number of variable attenuators 21C-i, not for each channel but for each pair of adjacent wavelengths λ₂ₖ₋₁ and λ₂ₖ in a lump.

Therefore, also in this example, the number of the variable attenuators 21C-i can be reduced and the circuit for controlling the variable attenuators 21C-i can be scaled down, thereby overall cost reduction and miniaturization of the optical multiplexing unit 21′ become possible and the stability of the optical multiplexing unit 21′ can also be improved. Further, the optical path from the modulator 21B-i to the optical coupler 21G-k can also be set short in this example, by which the multiplexing of the adjacent wavelengths λ₂ₖ₋₁ and λ₂ₖ maintaining the phase synchronization becomes easier.

(F) Second Modification of Optical Multiplexing Unit 21

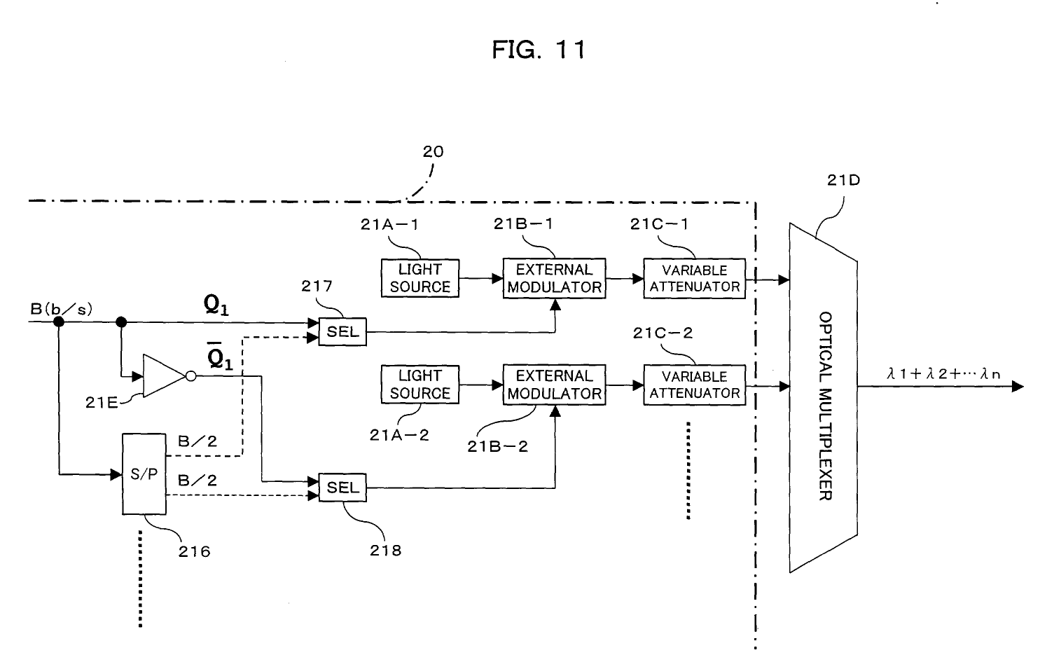

The optical multiplexing unit 21 (optical signal generation means 20) which has been explained referring to FIG. 2 (or FIG. 9) can be modified employing the composition of FIG. 11, for example.

In the example of FIG. 11, each pair of the adjacent wavelengths λ₂ₖ₋₁ and λ₂ₖ is provided with a serial/parallel (S/P) conversion unit 216 for carrying out serial/parallel conversion to the signal Qk to be transmitted and reducing its signal rate (10 Gbps, for example) to half (5 Gbps), a selector 217 for selecting one from the output of the S/P conversion unit 216 (half) and the signal Qk and outputting the selected signal as the modulation signal for the modulator 21B-(2k−1), and a selector 218 for selecting one from the output of the S/P conversion unit 216 (the other half) and the output of the aforementioned inverter gate 21E and outputting the selected signal as the modulation signal for the modulator 21B-2k.

In short, the S/P conversion unit 216 functions as a transmission rate conversion unit for converting the transmission rate of the signal Qk, and the selectors 217 and 218 function as a selector unit for selecting the signal pair (i.e. the signal Qk and the output of the inverter gate 21E) or the outputs of the S/P conversion unit 216 and inputting the selected signals to the modulators 21B-(2k−1) and 21B-2k respectively. Setting of each selector (217, 218) regarding which signal to select is done by external setting, for example.

In the optical multiplexing unit 21 constructed as above, the outputs of the selectors 217 and 218 are switched depending on required transmission bandwidth and the condition of the optical fiber transmission lines 5-1 and 5-2, thereby its operating mode can be switched between: “crosstalk suppression mode” in which the signal Qk and its inversion signal Qk* are transmitted using the two wavelengths λ₂ₖ₋₁ and λ₂ₖ at the original transmission rate of 10 Gbps; and “rate conversion mode” in which the signal Qk only is transmitted using the two wavelengths λ₂ₖ₋₁ and λ₂ₖ at the reduced transmission rate of 5 Gbps.

By the above composition, a device (transmitting station 2) with high value added, capable of adapting to diverse characteristics of various optical transmission lines and meeting customers' requests for upgrading from initial composition, can be provided. The “rate conversion mode” can be used when suppression of waveform deterioration is difficult due to high dispersion in the optical fiber transmission lines 5-1 and 5-2 or when the transmission of high-bit-rate signals is difficult due to high nonlinearity, and the “crosstalk suppression mode” can be used when the Raman amplification is employed in order to cope with long transmission distance (repeating distance).

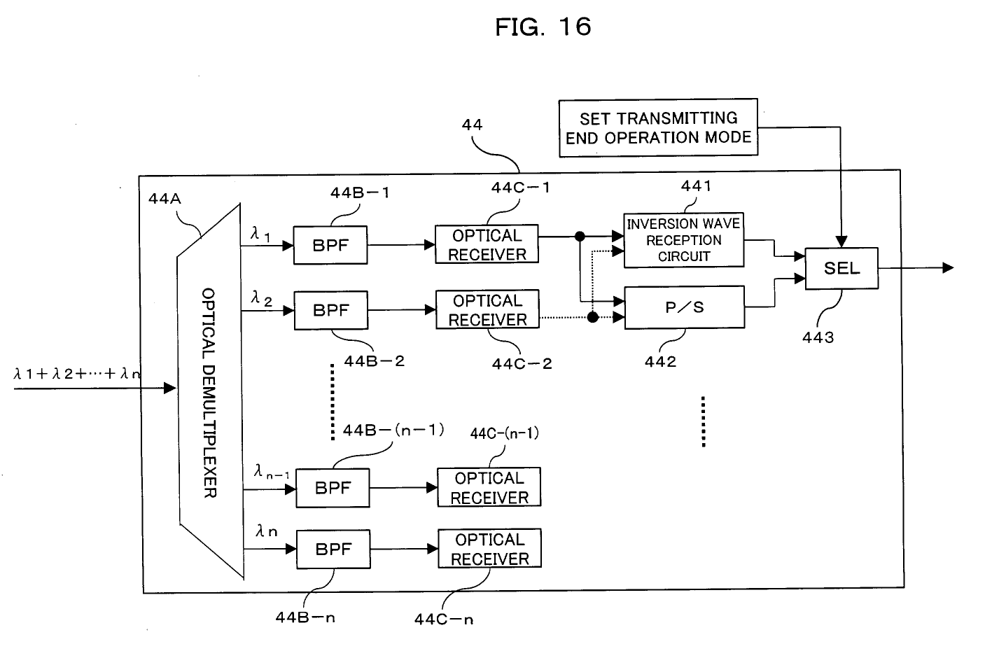

Incidentally, when the above composition is employed for the optical multiplexing unit 21 of the transmitting station 2, the optical demultiplexing unit 44 of the receiving station 4 also employs a composition that is capable of the selection between the “crosstalk suppression mode” and the “rate conversion mode”. Such a composition of the optical demultiplexing unit 44 will be explained later referring to FIG. 16.

(G) Optical Demultiplexing Unit 44 of Receiving Station 4

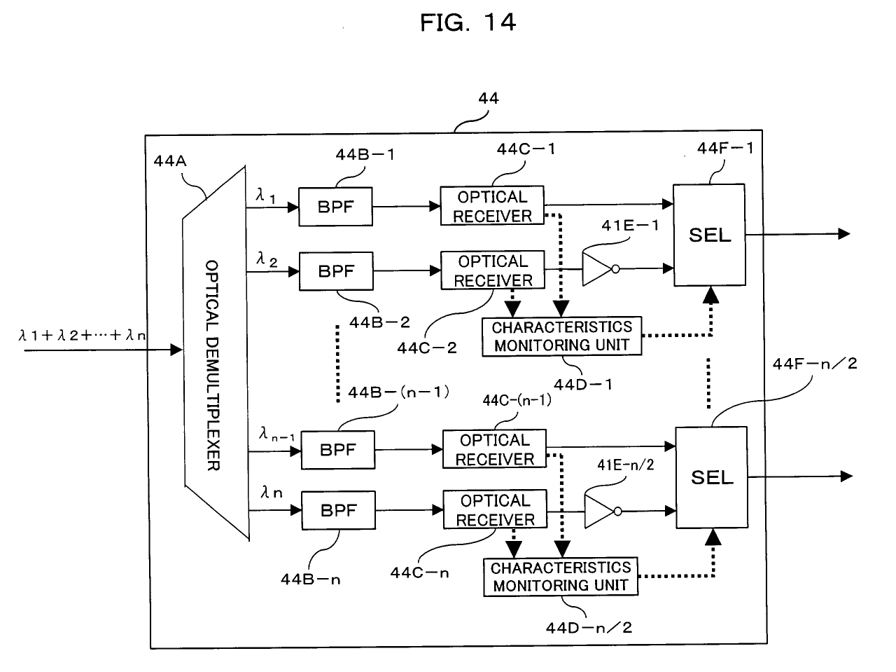

FIG. 14 is a block diagram showing the composition of the optical demultiplexing unit 44 of the receiving station 4. The optical demultiplexing unit 44 of FIG. 14 includes an optical demultiplexer 44A, BPFs (Band-Pass Filters) 44B-1 to 44B-n, optical receivers 44C-1 to 44C-n, characteristics monitoring units 44D-k (k=1 to n/2), inverter gates 44E-k, and selectors 44F-k.

The optical demultiplexer 44A demultiplexes the optical signal (WDM signal) supplied from the optical fiber transmission line 5-2 and preamplified by the EDFA 43 into optical signals of the wavelengths λ1 to λn. The optical demultiplexer 44A is implemented employing an arrayed waveguide grating filter, for example. Each BPF 44B-i passes only the optical signal of the wavelength component λi and removes unnecessary components including noise. Each optical receiver 44C-i carries out a reception process (photoelectric transfer etc.) for each optical signal supplied from a corresponding BPF 44B-i.

Each characteristics (quality) monitoring unit 44D-k monitors the characteristics (waveform, bit error rate, etc.) of the electric signal (corresponding to the wavelength λ₂ₖ₋₁) received and obtained by the optical receiver 44C-(2k−1) (referred to as “signal Q” here) and the electric signal (corresponding to the wavelength λ₂ₖ) received and obtained by the optical receiver 44C-2k (signal Qk*), and thereby monitors the quality of the signals of the wavelengths λ₂ₖ₋₁ and λ₂ₖ. Each inverter gate 44E-k inverts the inversion signal Qk* received by the optical receiver 44C-2k and thereby obtains the original signal Qk.

Each selector 44F-k makes a selection from the signal Q (corresponding to the wavelength λ₂ₖ₋₁) supplied from the optical receiver 44C-(2k−1) and the signal Qk (corresponding to the wavelength λ₂ₖ) supplied from the optical receiver 44C-2k. In this embodiment, the selection is carried out based on a selection control signal which is outputted by the characteristics monitoring unit 44D-k based on the monitoring result, by which a signal having better characteristics is selected as the received signal.

In the optical demultiplexing unit 44 of this embodiment configured as above, the WDM signal supplied from the EDFA 43 is demultiplexed by the optical demultiplexer 44A into the optical signals of the wavelengths λ1 to λn. Each optical signal is filtered by the BPF 44B-i for the removal of unnecessary components including noise, received by the optical receiver 44C-i, and thereby converted into an electric signal.

Meanwhile, each characteristics monitoring unit 44D-k monitors the signal quality of the signal Qk (λ₂ₖ₋₁) received by the optical receiver 44C-(2k−1) and the signal Qk* (λ₂ₖ) received by the optical receiver 44C-2k by calculating their bit error rates etc., and controls the selector 44F-k so that a signal having better signal characteristics will be selected.

By the above operation, a signal (corresponding to the wavelength λ₂ₖ₋₁ or λ₂ₖ) having better quality is selected as the working channel.

As described above, by the receiving station 4 (optical demultiplexing unit 44) of this embodiment making full use of the signal transmission by the transmitting station 2 transmitting a plurality of signals having the same information contents using a plurality of wavelengths λ₂ₖ₋₁ and λ₂ₖ, one of the signals that is received with better signal quality is selected as the working channel signal, by which better signal transmission characteristics can be ensured.

Further, even in cases where failure or abnormality has occurred in part of the transmitting station 2 (a light source 21A-i for a wavelength λi, for example) and reception power of the wavelength λi at the receiving station 4 dropped, signal reception can be continued normally using the other of the paired wavelengths. Therefore, safety and reliability like those of a duplex system (redundant system) can be obtained.

(H) First Modification of Optical Demultiplexing Unit 44

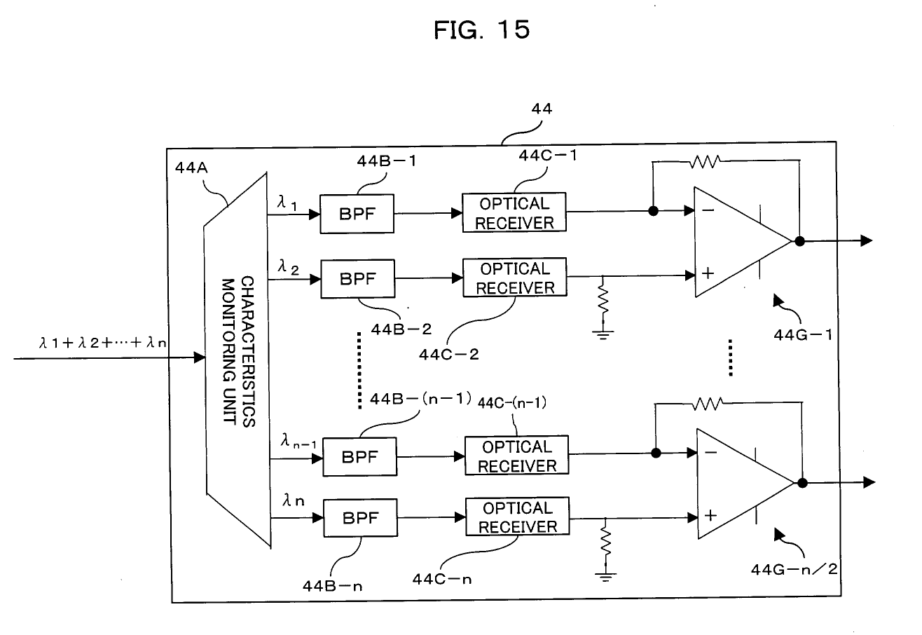

FIG. 15 is a block diagram showing a first modification of the above optical demultiplexing unit 44. The optical demultiplexing unit 44 of FIG. 15 includes differential amplifiers 44G-k (K=1 to n/2), as well as optical demultiplexer 44A, BPFs 44B-1 to 44B-n and optical receivers 44C-1 to 44C-n like those of FIG. 14.

Each differential amplifier 44G-k receives the electric signal (Qk) from the optical receiver 44C-(2k−1) and the electric signal (inversion signal Qk*) from the optical receiver 44C-2k, detects the difference between the signals, and thereby cancels out the DC (direct current) component of transmission line noise, according to a principle like that of a differential amplifier employed for reducing common-mode noise (in-phase noise) of an electric signal on a transmission line.

By the above composition, the optical demultiplexing unit 44 becomes capable of canceling out the in-phase noise components such as ASE (Amplified Spontaneous Emission) occurring in the optical fiber transmission lines 5-1 and 5-2 by use of the differential amplifiers 44G-k, thereby it becomes possible to attain a higher signal-to-noise ratio and support longer repeating distance.

(I) Second Modification of Optical Demultiplexing Unit 44

FIG. 16 is a block diagram showing a second modification of the optical demultiplexing unit 44. The optical demultiplexing unit 44 of FIG. 16, designed as the receiving end for the optical multiplexing unit 21 of FIG. 11 having the mode switching function between the “crosstalk suppression mode” and the “rate conversion mode”, includes inversion wave reception circuits 441, parallel/serial (P/S) conversion units 442 and selectors 443 corresponding to the composition of the transmitting end (see FIG. 11), as well as optical demultiplexer 44A, BPFs 44B-1 to 44B-n (for the wavelengths λ1 to λn) and optical receivers 44C-1 to 44C-n (for the wavelengths λ1 to λn) like those described above.

The inversion wave reception circuit 441 (which is a circuit corresponding to, for example, the circuit in FIG. 14 including the characteristics monitoring unit 44D-k, the inverter gate 44E-k and the selector 44F-k, or the differential amplifier 44G-k in FIG. 15) receives the outputs of the optical receivers 44C-(2k−1) and 44C-2k as its input.

When the operation mode of the transmitting station 2 is set to the “crosstalk suppression mode” the signal Qk transmitted using the wavelength λ₂ₖ₋₁ and the inversion signal Qk* transmitted using the wavelength λ₂ₖ are inputted to the inversion wave reception circuit 441. On the other hand, when the transmitting station 2 is set to the “rate conversion mode”, the signal Qk, which has been rate-converted (to half) by the S/P conversion unit 216 of the transmitting station 2 and transmitted using the two wavelengths λ₂ₖ₋₁ and λ₂ₖ, are inputted to the inversion wave reception circuit 441.

The P/S conversion unit 442 receives the outputs of the optical receivers 44C-(2k−1) and 44C-2k as its input and carries out P/S conversion (rate conversion) to the input signals, depending on the transmission rate conversion carried out by the S/P conversion unit 216 of the transmitting station 2. Therefore, the P/S conversion unit 442 doubles the transmission rate in the case where the S/P conversion unit 216 drops the transmission rate to half.

The selector 443 selects one of the outputs of the inversion wave reception circuit 441 and the P/S conversion unit 442 based on its operation mode which is set thereto corresponding to the operation mode of the transmitting station 2. The selector 443 selects the output of the inversion wave reception circuit 441 in the “crosstalk suppression mode”, and selects the output of the P/S conversion unit 442 in the “rate conversion mode”.

In the optical demultiplexing unit 44 configured as above, the output of the inversion wave reception circuit 441 becomes valid in the “crosstalk suppression mode”, by which one of the signal Qk (transmitted using the wavelength λ₂ₖ₋₁) and the signal Qk* (transmitted using the wavelength λ₂ₖ) having better signal quality or the difference detection result by the differential amplifier 44G-k is outputted. In the “rate conversion mode”, the output of the P/S conversion unit 442 becomes valid and the signal Qk, which has been transmitted from the transmitting station 2 using two wavelengths λ₂ₖ₋₁ and λ₂ₖ at a reduced transmission rate (e.g. 5 Gbps) is outputted at a raised transmission rate (e.g. 10 Gbps).

As above, by letting the optical demultiplexing unit 44 operate according to the operation mode setting of the transmitting station 2, similarly to the case of the transmitting side, a device (receiving station 4) with high value added, capable of adapting to diverse characteristics of various optical transmission lines and meeting customers' requests for upgrading from initial composition, can be provided.

(J) Other Examples

When multistage optical amplification repeating is carried out as schematically shown in FIG. 18(A), the delay between the signals Qk and Qk* of different wavelengths due to the wavelength dispersion property of the optical fiber transmission line 5 accumulates as the transmission (repeating) distance gets longer as shown in FIG. 18(B) . On the other hand, the Raman amplification effect by the forward-pumping becomes the strongest just after the transmitting station 2 or the repeater station 3 (transmitting end) as explained before referring to FIG. 18(D).

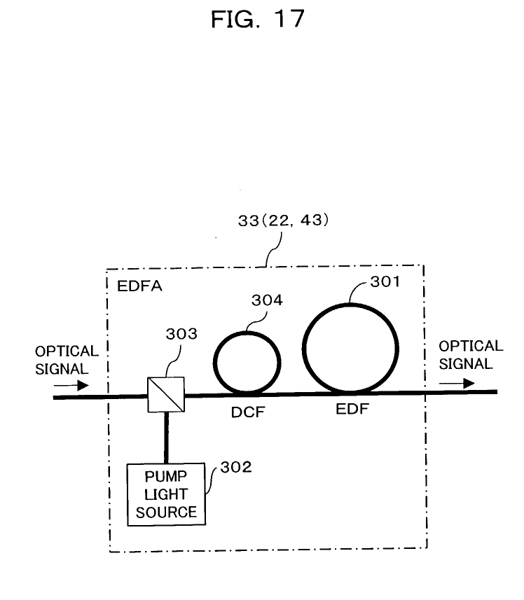

Therefore, in order to suppress the “inter-channel crosstalk” effectively also at the repeater stations 3, it is desirable that each repeater station 3 be provided with a function for compensating for the delay between the signals Qk and Qk*. Therefore, a DCF (Dispersion Compensating Fiber) 304, as a dispersion compensator having a dispersion value capable of compensating for the effect of the wavelength dispersion property of the optical fiber transmission line 5 is provided to the repeater station 3 as shown in FIG. 17, for example. The DCF 304 is generally placed in front of the EDF 301 since input optical power to the DCF 304 has a certain limitation (too high input optical power causes much noise).

By the above composition, the delay between the signals Qk and Qk* can be eliminated at the output of each repeater station 3 as shown in FIG. 18(C). Consequently, even in such a system 1 carrying out the multistage optical amplification repeating, the inter-channel crosstalk suppression effect can effectively be achieved across the whole transmission length, only by providing a DCF 304 to each repeater station 3.

Incidentally, since the “Raman amplification” employs the very long (several to tens of kilometers) optical fiber transmission line 5 itself as the amplification medium, the mechanism and status of the crosstalk varies depending on dispersion/loss properties of the optical fiber transmission line 5. Therefore, there might be cases where signal transmission with the above perfect synchronization of the signals Qk and Qk* (delay=0) does not result in optimum transmission characteristics.

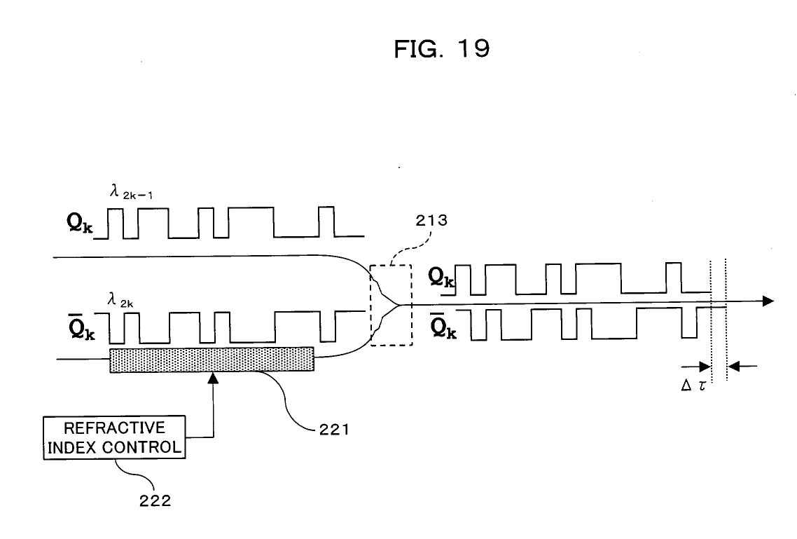

In such cases, an electrode 221 may be provided to the path (dielectric optical waveguide, etc.) of the optical inversion signal Qk* (or the optical signal Qk) as schematically shown in FIG. 19 and FIG. 7, for example. By letting a refractive index control circuit (timing control circuit) 222 apply voltage to the electrode 221 so as to control the refractive index of light, the optical path length for the inversion signal Qk* (or the optical signal Qk) can be adjusted.

By the above composition, the differential delay Δτ between the signal Qk and the inversion signal Qk* (or the output timing of the signals Qk and Qk*) can be adjusted properly. By the adjustment of the differential delay Δτ, transmission characteristics (including those affected by temperature variation, secular change, etc.) can be optimized even after the start of system operation and the crosstalk suppression effect can be maximized constantly.

Incidentally, while the crosstalk suppression effect was achieved in the above embodiment by transmitting the signal Qk (or the signals Qk and Qk* having the same information) by use of two adjacent wavelengths λ₂ₖ₋₁ and λ₂ₖ, it is also possible to obtain the crosstalk suppression effect using three of more wavelengths.

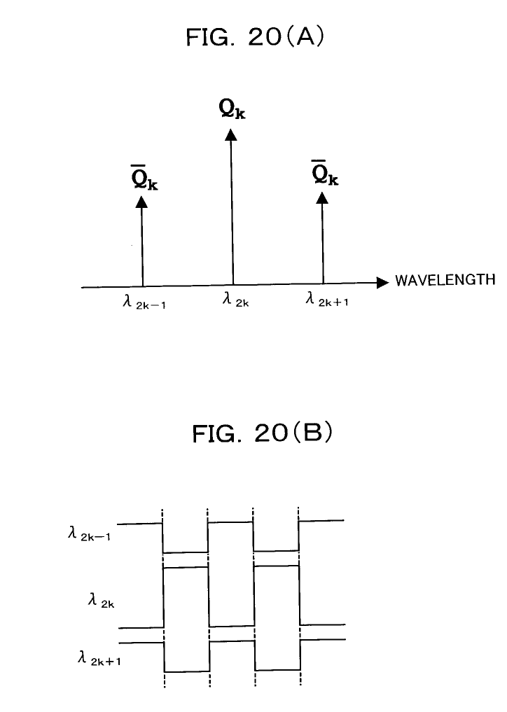

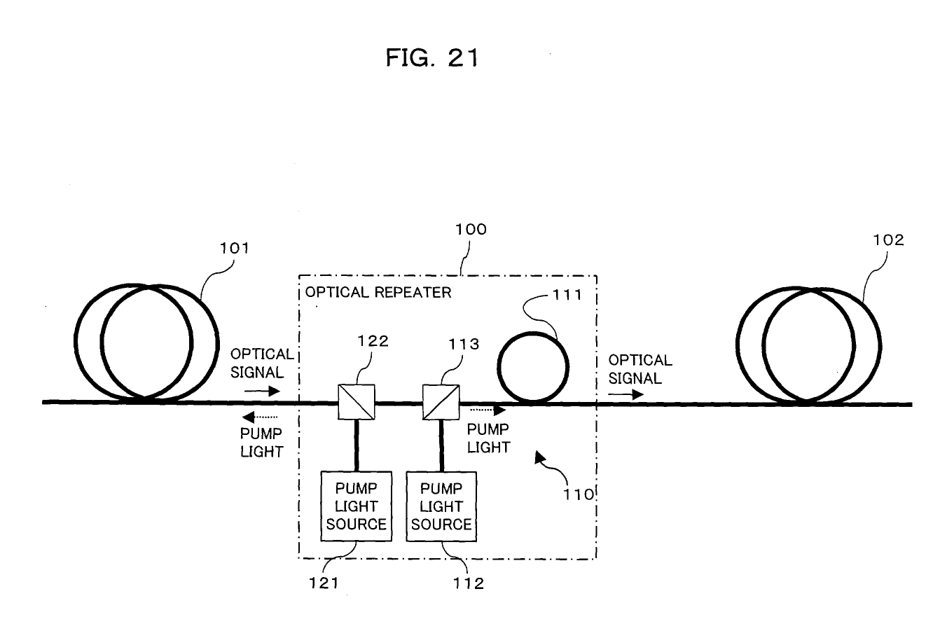

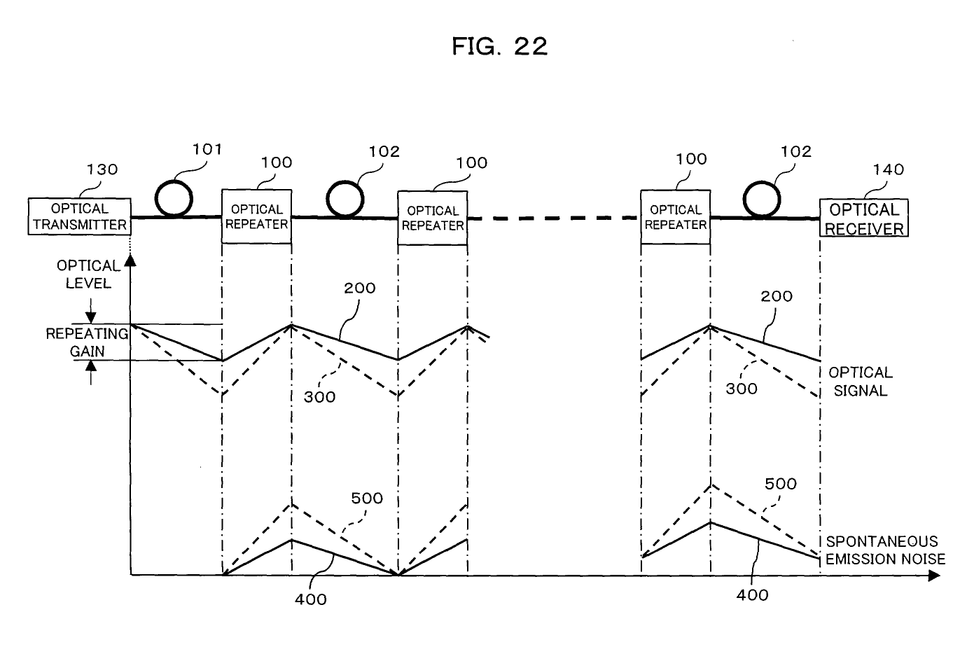

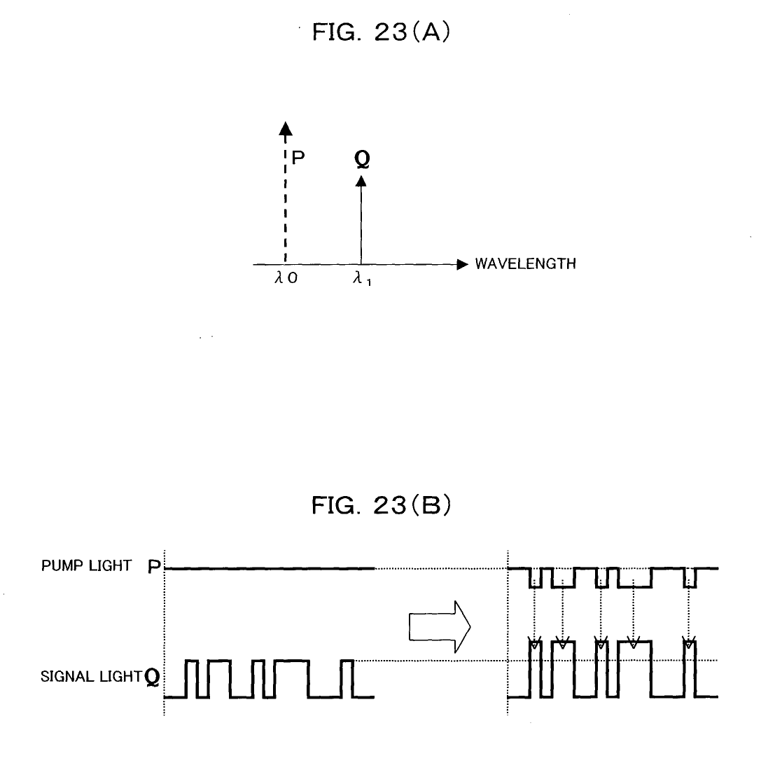

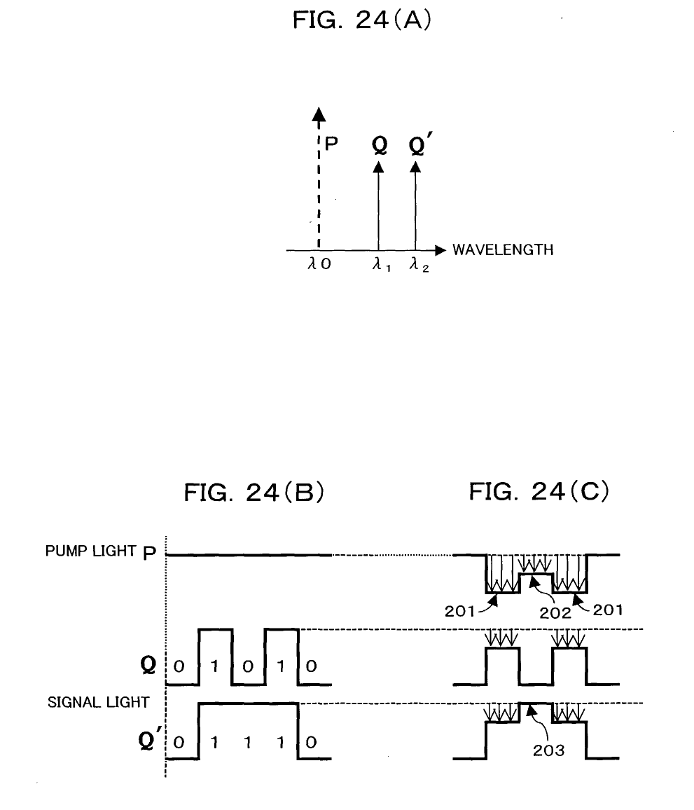

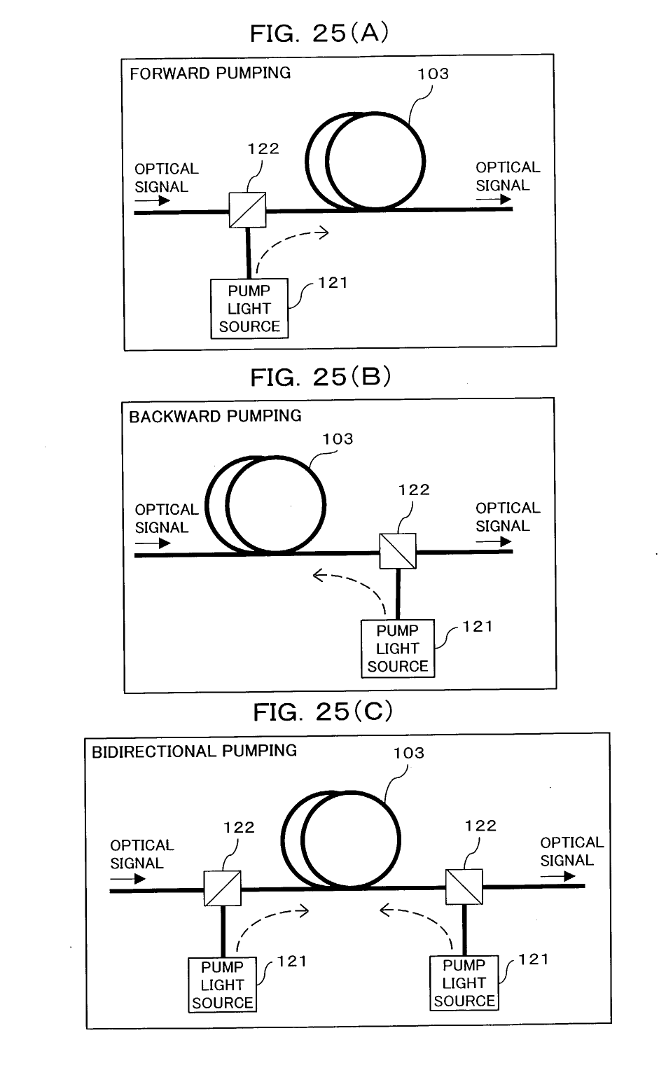

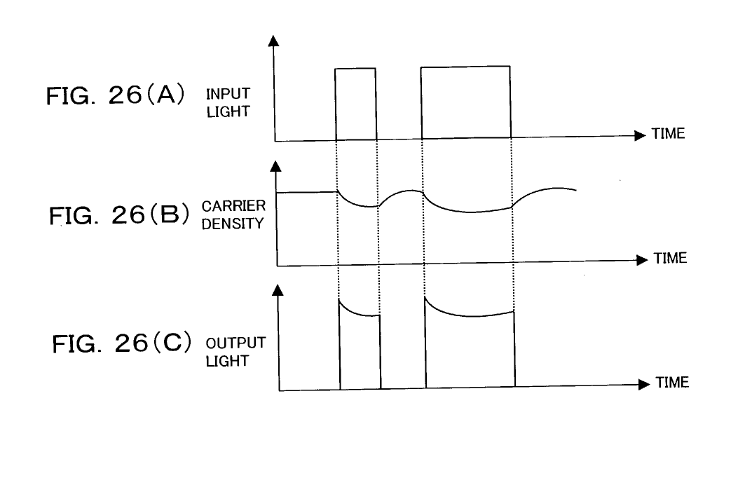

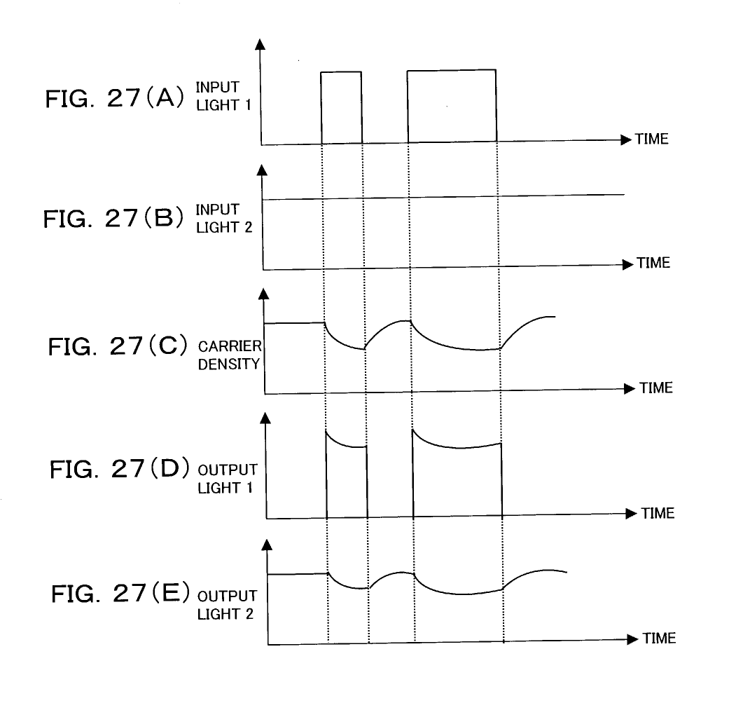

For example, when three wavelengths are used for example, the main signal Qk is transmitted using a wavelength λ₂ₖ and the inversion signal Qk* is transmitted using two wavelengths λ₂ₖ₋₁ and λ₂ₖ₊₁ with half the level (power) of the signal Qk as shown in FIGS. 20(A) and 20(B). Also in this case, by wavelength division multiplexing and transmitting the optical signals of the wavelengths λ₂ₖ₋₁, λ₂ₖ and λ₂ₖ₊₁ in a synchronized state, the total optical power can be maintained constant, thereby the modulation effect on the Raman pump light can be reduced and the crosstalk can be suppressed.

While crosstalk suppression in the case where “Raman amplification” is employed has been explained consistently in the above embodiment, the effects of the embodiment can be obtained also when semiconductor optical amplifiers are employed.

By inputting the signal Qk and the inversion signal Qk* to a semiconductor optical amplifier in a synchronized state, total power of the signals Qk and Qk* becomes constant and the variation of carrier density in the active area of the semiconductor optical amplifier can be reduced. Consequently, the variation of gain and signal waveform deterioration due to “pattern effect” can be reduced and the crosstalk can be suppressed effectively.

Incidentally, the “inversion signal Qk*” is not necessarily required to be the perfect inversion of the signal Qk. In other words, even if the inversion signal Qk* has optical power and a waveform that are slightly different from those of the signal Qk, the total power becomes almost constant and enough crosstalk suppression effect can be obtained.

While the external modulation method (modulating the optical signal from the light source 21A-i from outside by use of the signal Qk/Qk*) has been employed in the above embodiment, it is also possible to employ the direct modulation method (modulating the optical signal by directly inputting the signal Qk/Qk* to the light source 21A-i).

While the application of the present invention to a hybrid system (including the combination of EDFAs 32 (33, 43) and Raman amplifiers (or semiconductor optical amplifiers)) has been explained in the above embodiment, the aforementioned effects can be obtained also when the present invention is applied to WDM optical transmission systems employing Raman amplifiers (or semiconductor optical amplifiers) only.

While the signal Qk and the inversion signal Qk* are transmitted by use of adjacent wavelengths λ₂ₖ₋₁ and λ₂ₖ₊₁ in the above embodiment, there are cases where the wavelengths are not necessarily required to be adjacent. For example, when a semiconductor optical amplifier is employed instead of the Raman amplifier, the size of the active area where the optical signal is amplified is approximately some 100 μm to 1 mm, in which the effect of delay caused by wavelength dispersion is negligible, differently from the case where the optical fiber transmission line 5 is used as the amplification medium. Therefore, the wavelengths are not required to be adjacent and any wavelengths in the gain band can be used in the case where semiconductor optical amplifiers are used.

While Raman amplification of the bidirectional-pumping type was employed for the WDM optical transmission system 1 of the above embodiment, the aforementioned effects of the present invention can of course be obtained also when only forward-pumping is employed. Further, while all of the signals Qk to be transmitted were transmitted together with the paired inversion signals Qk* in the above embodiment, it is also possible to use the inversion signals Qk* for some or part of the signals Qk.

For example, when the signals can successfully be transmitted for a necessary distance with sufficient signal quality using the inversion signals Qk* for some or part of the signals Qk, it is possible to carry out the conventional signal transmission (without the inversion signals Qk*) for the rest of the signals Qk. It is also possible to carry out signal transmission employing the paired signals Qk and Qk* for some wavelengths that are going to have optical power affecting other wavelengths (channels) due to wavelength-dependent loss characteristics of the optical transmission line or optical amplifier and carry out the conventional signal transmission (without the inversion signals Qk*) for the other wavelengths.

By such signal transmission, even if optical power variation among the wavelengths occurred due to the wavelength-dependent loss characteristics of the optical transmission line or optical amplifier, the effect of crosstalk caused by such optical power variation can be suppressed.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

### INDUSTRIAL APPLICABILITY

As set forth hereinabove, by the present invention, the inter-channel crosstalk, which becomes noticeable when Raman amplification of forward-pumping is employed in a WDM optical transmission system, can be suppressed effectively, independently of the performance/characteristics of optical devices, thereby the wavelength division multiplexed optical signals can be transmitted for longer distances and with lower noise in comparison with conventional optical transmission techniques. Therefore, the usability and applicability of the present invention are remarkably high.

What is claimed is:

1. An optical transmitter comprising:
optical signal generating means for generating a main signal to be transmitted and its inversion signal as optical signals of different wavelengths; and
wavelength division multiplexing means for wavelength division multiplexing said optical signals of different wavelengths generated by said optical signal generating means and transmitting the multiplexed optical signal.

2. The optical transmitter according to claim 4, wherein said optical signal generating means is configured to output said main signal and said inversion signal in a synchronized state.

3. The optical transmitter according to claim 1, wherein said optical signal generating means includes:
an inverter circuit for inverting said main signal as an electric signal;
a first light source for generating light having a certain wavelength;
a second light source for generating light having a wavelength different from that of said light generated by said first light source;
a first modulator for modulating said light from said first light source using said main signal; and
a second modulator for modulating said light from said second light source using the output of said inverter circuit.

4. The optical transmitter according to claim 3, wherein the optical path length from said first modulator to said wavelength division multiplexing means is set equal to the optical path length from said second modulator to said wavelength division multiplexing means.

5. The optical transmitter according to claim 4, wherein said optical signal generating means includes a variable attenuator for controlling the output level of each modulator.

6. The optical transmitter according to claim 3, wherein:
said optical signal generating means includes an optical coupler for coupling the outputs of said first and second modulators, and
the optical path length from said first modulator to said optical coupler is set equal to the optical path length from said second modulator to said optical coupler.

7. The optical transmitter according to claim 6, wherein said optical signal generating means includes a variable attenuator for controlling the output level of said optical coupler.

8. The optical transmitter according to claim 3, wherein said optical signal generating means includes:
a transmission rate conversion unit for carrying out transmission rate conversion to said main signal and thereby obtaining a pair of signals of reduced transmission rate; and
a selection unit for selecting a pair of signals composed of said main signal and the output of said inverter circuit or said pair of signals outputted by said transmission rate conversion unit and inputting the selected signals to said first and second modulators respectively.

9. The optical transmitter according to claim 1, wherein said optical signal generating means includes:
a first light source for generating light having a certain wavelength;
a second light source for generating light having a wavelength different from that of said light generated by said first light source;
a first modulator for modulating said light from said first light source using a main signal as an electric signal;
a second modulator for modulating said light from said second light source using said main signal as an electric signal; and
a modulation status control circuit for controlling the modulation statuses of said first and second modulators so that said main signal as an optical signal will be outputted by one of said first and second modulators and said inversion signal as an optical signal will be outputted by the other of said first and second modulators.

10. The optical transmitter according to claim 9, wherein the optical path length from said first modulator to said wavelength division multiplexing means is set equal to the optical path length from said second modulator to said wavelength division multiplexing means.

11. The optical transmitter according to claim 10, wherein said optical signal generating means includes a variable attenuator for controlling the output level of each modulator.

12. The optical transmitter according to claim 9, wherein:
said optical signal generating means includes an optical coupler for coupling the outputs of said first and second modulators, and
the optical path length from said first modulator to said optical coupler is set equal to the optical path length from said second modulator to said optical coupler.

13. The optical transmitter according to claim 12, wherein said optical signal generating means includes a variable attenuator for controlling the output level of said optical coupler.

14. The optical transmitter according to claim 9, wherein said first and second modulators are composed as a Mach-Zehnder optical modulator/multiplexer which multiplexes the outputs of different output ports of two Mach-Zehnder optical modulators.

15. The optical transmitter according to claim 1, wherein said optical signal generating means includes:
an optical multiplexer for multiplexing said main signal as an optical signal and a DC (Direct Current) signal as an optical signal; and
a semiconductor optical amplifier to which the output of said optical multiplexer is inputted.

16. The optical transmitter according to claim 1, wherein said wavelength division multiplexing means is implemented by use of an optical multiplexer whose pass band per channel covers said different wavelengths.

17. The optical transmitter according to claim 1, wherein said optical signal generating means includes a timing control circuit for controlling output timing of said main signal and said inversion signal.

18. The optical transmitter according to claim 1, wherein said different wavelengths are adjacent wavelengths.

19. An optical transmitter comprising:
a plurality of light sources for generating lights of different wavelengths;
a plurality of modulators which are provided corresponding to said light sources, each of which modulate said light from said corresponding light source using a main signal to be transmitted;
a plurality of optical couplers each of which couples the outputs of said modulators corresponding to at least two adjacent wavelengths;
a plurality of variable attenuators for controlling the output levels of said optical couplers; and
an optical multiplexer for multiplexing the outputs of said variable attenuators.

20. An optical repeater for repeating an optical signal transmitted by an optical transmitter that transmits a main signal to be transmitted and its inversion signal as a wavelength division multiplexed optical signal containing optical signals of different wavelengths corresponding to said main signal and said inversion signal, comprising a dispersion compensator for compensating for wavelength dispersion of said main signal and said inversion signal.

21. An optical receiver for receiving an optical signal transmitted by an optical transmitter that transmits a main signal to be transmitted and its inversion signal as a wavelength division multiplexed optical signal containing optical signals of different wavelengths corresponding to said main signal and said inversion signal, comprising:
a quality monitoring unit for monitoring the quality of said main signal and said inversion signal; and
a selection unit for selecting said main signal or said inversion signal as a received signal depending on the result of quality monitoring by said quality monitoring unit.

22. An optical receiver for receiving an optical signal transmitted by an optical transmitter that transmits a main signal to be transmitted and its inversion signal as a wavelength division multiplexed optical signal containing optical signals of different wavelengths corresponding to said main signal and said inversion signal, comprising:
an optical demultiplexer for demultiplexing said wavelength division multiplexed optical signal and obtaining said main signal and said inversion signal; and
a differential amplifier to which said main signal and said inversion signal from said optical demultiplexer are inputted.

23. An optical transmission method, wherein a main signal to be transmitted and its inversion signal are transmitted as optical signals of different wavelengths by means of wavelength division multiplexing.

24. The optical transmission method according to claim 23, wherein said main signal and said inversion signal are transmitted in a synchronized state.

25. The optical transmission method according to claim 24, wherein said different wavelengths are adjacent wavelengths.

26. The optical transmission method according to claim 23, wherein said different wavelengths are adjacent wavelengths.
